(19) United States
(12) Patent Application Publication
(10) Pub. No.: US 2022/0069413 A1
(43) Pub. Date: Mar. 3, 2022

(54) SEPARATOR FOR NON-AQUEOUS SECONDARY BATTERY, SECONDARY BATTERY, AND MANUFACTURING METHOD OF SECONDARY BATTERY

(71) Applicant: FUJIFILM BUSINESS INNOVATION CORP., Tokyo (JP)

(72) Inventors: Kosuke NAKADA, Minamiashigara-shi (JP); Yasunobu KASHIMA, Minamiashigara-shi (JP); Kosaku YOSHIMURA, Minamiashigara-shi (JP); Tomoya SASAKI, Minamiashigara-shi (JP); Hajime SUGAHARA, Minamiashigara-shi (JP); Tomoyo OKUBO, Minamiashigara-shi (JP); Hidekazu HIROSE, Minamiashigara-shi (JP)

(73) Assignee: FUJIFILM BUSINESS INNOVATION CORP., Tokyo (JP)

(21) Appl. No.: 17/137,876

(22) Filed: Dec. 30, 2020

(30) Foreign Application Priority Data
Sep. 3, 2020 (JP) 2020-148426

(51) Int. Cl. H01M 50/423; H01M 50/429; H01M 50/403; H01M 50/46; H01M 50/491; H01M 50/494; H01M 50/449

(52) U.S. Cl. CPC H01M 50/423; H01M 50/429; H01M 50/403; H01M 50/449; H01M 50/491; H01M 50/494; H01M 50/461

(57) ABSTRACT

A separator for a non-aqueous secondary battery includes: a polyimide porous film; and adhesive resin particles that are attached to a surface of the polyimide porous film and have a responsiveness to at least one of pressure and heat.

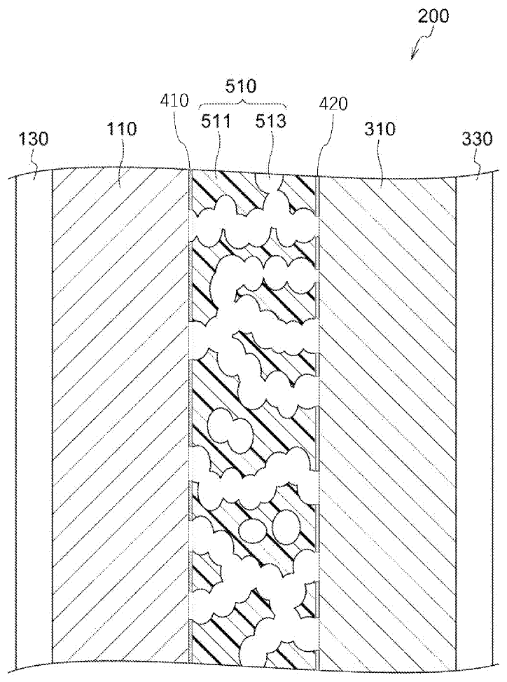

### CROSS-REFERENCE TO RELATED APPLICATIONS

This application is based on and claims priority under 35 USC 119 from Japanese Patent Application No. 2020-148426 filed on Sep. 3, 2020.

### BACKGROUND

### Technical Field

The present disclosure relates to a separator for a non-aqueous secondary battery, a secondary battery, and a manufacturing method of a secondary battery.

### Related Art

In JP-A-2019-117800, a laminated body including a separator for a secondary battery including one or more heat-resistant layers, and an adhesive layer containing an adhesive resin that is a copolymer of a specific monomer and has a glass transition temperature of −15 to 7° C., in which a coverage rate of the surface of the separator for a secondary battery to be measured by using a digital microscope at 200-fold magnification is 5 to 100%, is described.

In JP-A-2013-134858, a separator for a non-aqueous secondary battery including a non-woven base material, and an adhesive porous layer that is formed at least on the surface of the base material and contains a polyvinylidene fluoride-based resin is described.

### SUMMARY

Aspects of non-limiting embodiments of the present disclosure relate to a separator for a non-aqueous secondary battery in which a secondary battery having excellent adhesiveness with respect to an electrode and high cycle characteristics may be obtained compared to a separator for a non-aqueous secondary battery adhering to an electrode by using a liquid or layered adhesive agent.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a separator for a non-aqueous secondary battery, including:
a polyimide porous film; and
adhesive resin particles that are attached to a surface of the polyimide porous film and have a responsiveness to at least one of pressure and heat.

### BRIEF DESCRIPTION OF THE DRAWINGS

Exemplary embodiment of the present invention will be described in detail based on the following FIGURE, wherein:

The FIGURE is a partial sectional schematic view illustrating an example of a secondary battery (specifically, a lithium ion secondary battery) according to the present exemplary embodiment.

### DETAILED DESCRIPTION

Hereinafter, an exemplary embodiment of the disclosure will be described. Such description and examples exemplify the exemplary embodiment, and do not limit the scope of the exemplary embodiment.

In the disclosure, a numerical range represented by using “to” indicates a range including numerical values before and after “to” as the minimum value and the maximum value, respectively.

In a numerical range described in a stepwise manner in the disclosure, an upper limit value or a lower limit value described in one numerical range may be replaced with an upper limit value or a lower limit value of the other numerical range that is described in a stepwise manner. In addition, in the numerical range described in the disclosure, the upper limit value or the lower limit value of the numerical range may be replaced with values described in the examples.

In the disclosure, the term of “step” includes not only an independent step but also a step of which the intended object is attained even in a case where the step is not capable of being distinctively distinguished from the other steps.

In the disclosure, in a case where the exemplary embodiment is described with reference to the drawing, the configuration of the exemplary embodiment is not limited to a configuration illustrated in the drawing. In addition, the sizes of members in each drawing are conceptual, and a relative relationship between the sizes of the members is not limited thereto.

In the disclosure, each component may contain a plurality of types of corresponding substances. In a case where there are a plurality of types of substances corresponding to each component in a composition, the amount of each of the components in the composition, noted in the disclosure, indicates the total amount of the plurality of types of substances existing in the composition, unless otherwise noted.

In the disclosure, particles corresponding to each component may include a plurality of types of particles. In a case where there are a plurality of types of particles corresponding to each component in a composition, a particle diameter of each of the components indicates a value of a mixture of the plurality of types of particles existing in the composition, unless otherwise noted.

In the disclosure, the notation of “(meth)acryl” indicates that (meth)acryl may be either “acryl” or “methacryl”.

<Separator for Non-Aqueous Secondary Battery>

A polyimide porous film is a hard film due to a polyimide resin, and thus, may have poor cohesiveness with respect to other materials. For this reason, in a secondary battery using the polyimide porous film as a separator for a non-aqueous secondary battery, a gap may be formed between the separator and an electrode, in accordance with charge and discharge. In a case where an air gap is formed between the separator and the electrode in the secondary battery, it is difficult for ions to be moved, and cycle characteristics decrease.

In the related art, there is a technology for providing an adhesive layer between a separator and an electrode, but cohesiveness between the separator and the electrode is insufficient due to the adhesive layer, and even in a case where the cohesiveness between the separator and the electrode is sufficient, the movement of ions is inhibited, and cycle characteristics are insufficient, and thus, there is room for further studies.

Therefore, the present inventors have conducted intensive studies about a separator for a non-aqueous secondary battery, and thus, have found that a secondary battery having excellent cohesiveness with respect to an electrode and high cycle characteristics may be obtained by attaching “adhesive resin particles” to the surface of a polyimide porous film (that is, an adhesive interface with the electrode).

A separator for a non-aqueous secondary battery (hereinafter, also simply referred to as a “separator”) according to the present exemplary embodiment, includes: a polyimide porous film; and adhesive resin particles that are attached to a surface of the polyimide porous film and have a responsiveness to at least one of pressure and heat.

[Preferred Aspect]

In the separator according to the present exemplary embodiment, it is preferable that when an average pore diameter of the polyimide porous film is set to X, and an average particle diameter of the adhesive resin particles is set to Y, a relationship of X<Y is satisfied.

In the aspect in which the average particle diameter Y of the adhesive resin particles is larger than the average pore diameter X of the polyimide porous film, the embedment of the adhesive resin particles with respect to an opening portion of the polyimide porous film may be suppressed. As a result thereof, in the separator of this aspect, the cohesiveness with respect to the electrode may be further improved, and a secondary battery having high cycle characteristics may be obtained.

Here, the average particle diameter of the adhesive resin particles indicates a volume average particle diameter (D50v) of the adhesive resin particles. In the separator according to the present exemplary embodiment, a ratio Y/X of the average particle diameter Y of the adhesive resin particles to the average pore diameter X of the polyimide porous film is preferably more than 1.0 and 70.0 or less, is more preferably more than 1.0 and 65.0 or less, is even more preferably more than 1.0 and 60.0 or less, and is particularly preferably more than 1.0 and 55 or less.

In the aspect in which Y/X is more than 1.0, the embedment of the adhesive resin particles with respect to the opening portion of the polyimide porous film may be more effectively suppressed. In addition, in the aspect in which Y/X is 70.0 or less, the formation of the air gap between the separator and the electrode due to coarse particles may be suppressed. As a result thereof, in the separator of this aspect, the cohesiveness with respect to the electrode may be further improved, and the secondary battery having high cycle characteristics may be obtained.

In the separator according to the present exemplary embodiment, an attachment amount of the adhesive resin particles with respect to the surface of the polyimide porous film is preferably 0.5 g/m² or more and 5.0 g/m² or less, is more preferably 0.8 g/m² or more and 4.8 g/m² or less, and is even more preferably 1.0 g/m² or more and 4.5 g/m² or less, from the viewpoint that the cohesiveness with respect to the electrode may be further improved, and the secondary battery having high cycle characteristics may be obtained.

The attachment amount of the adhesive resin particles with respect to the surface of the polyimide porous film is measured as follows.

First, the polyimide porous film having the adhesive resin particles attached to the surface is cut into a size of 50 mm square. The obtained measurement sample is dipped in tetrahydrofuran at 25° C. for 30 minutes such that the adhesive resin particles are dissolved or dispersed in tetrahydrofuran.

The amount [g] of adhesive resin particles attached to the surface of the polyimide porous film is obtained from a mass difference of the measurement sample before and after being dipped, and the amount is divided by the area [m²] of the measurement sample, and thus, the attachment amount is obtained.

Hereinafter, the details of the adhesive resin particles and the polyimide porous film of the separator according to the present exemplary embodiment will be described.

[Adhesive Resin Particles]

The separator according to the present exemplary embodiment includes the adhesive resin particles that are attached to the surface of the polyimide porous film and have a responsiveness to at least one of pressure and heat.

Here, the adhesive resin particles indicate resin particles in which adhesiveness is exhibited or the adhesiveness is improved, in response to the application of at least one of pressure and heat.

In addition, the resin particles indicate particles of which a main component is a resin, and specifically, particles containing 80 mass % or more of a resin with respect to the mass of the particles.

The adhesive resin particles having a responsiveness to at least one of pressure and heat are not particularly limited insofar as being resin particles in which the adhesiveness is exhibited or the adhesiveness is improved in accordance with the application of at least one of pressure and heat, and examples thereof include adhesive resin particles mainly having a responsiveness to heat (that is, heat-responsive particles) and adhesive resin particles mainly having a responsiveness to pressure (that is, pressure-responsive particles), from the viewpoint of availability, handleability, or the like.

Among them, the pressure-responsive particles having a responsiveness to pressure are preferably used as the adhesive resin particles, from the viewpoint that it is difficult to block the opening portion of the polyimide porous film, and the adhesiveness between the electrode and the polyimide porous film is excellent.

[Adhesive Resin Particles Having a Responsiveness to Heat (Heat-Responsive Particles)]

Examples of the adhesive resin particles having a responsiveness to heat (that is, the heat-responsive particles) include resin particles corresponding to a so-called hot-melt adhesive agent. That is, examples of the heat-responsive particles include resin particles containing a thermoplastic resin that is softened or melted at a temperature of 80° C. or higher.

Examples of the resin contained in the heat-responsive particles include known resins used in the hot-melt adhesive agent, and specifically, include an ethylene vinyl acetate copolymer (EVA); polyolefin such as polypropylene and polyethylene; polyamide; polyurethane; an acrylic resin; and synthetic rubber.

A volume average particle diameter (D50v) of the heat-responsive particles is preferably 0.2 μm or more and 30.0 μm or less, and is more preferably 0.4 μm or more and 28.0 μm or less, from the viewpoint of manufacturability and the availability.

Here, a measurement method of the volume average particle diameter (D50v) of the heat-responsive particles is identical to a measurement method of a volume average particle diameter (D50v) of the pressure-responsive particles, described below.

[Adhesive Resin Particles Having a Responsiveness to Pressure (Pressure-Responsive Particles)]

It is preferable that the adhesive resin particles having a responsiveness to pressure (that is, the pressure-responsive particles) are particles to be subjected to a phase transition in accordance with the application of pressure.

Specifically, it is preferable that the pressure-responsive particles contain a styrene-based resin containing styrene and a vinyl monomer other than styrene as a polymerization component, and a (meth)acrylic ester-based resin containing at least two types of (meth)acrylic ester as a polymerization component, have at least two glass transition temperatures, and have a difference between the lowest glass transition temperature and the highest glass transition temperature of 30° C. or higher, from the viewpoint of improving the adhesiveness between the separator and the electrode.

As described above, the thermal characteristics of “having at least two glass transition temperatures and a difference between the lowest glass transition temperature and the highest glass transition temperature of 30° C. or higher” are exhibited, and thus, the pressure-responsive particles are subjected to the phase transition by pressure. In the disclosure, the pressure-responsive particles to be subjected to the phase transition by pressure indicate pressure-responsive particles satisfying Expression 1 described below.

In addition, as described above, the pressure-responsive particles contains the “styrene-based resin containing styrene and the vinyl monomer other than styrene as the polymerization component”, and the “(meth)acrylic ester-based resin containing at least the two types of (meth)acrylic ester as the polymerization component”, and thus, are easily subjected to the phase transition by pressure, and have excellent adhesiveness.

In general, compatibility between the styrene-based resin and the (meth)acrylic ester-based resin is low, and thus, it is considered that both of the resins are contained in the pressure-responsive particles in a phase-separated state. In addition, in a case where the pressure-responsive particles are pressurized, it is considered that the (meth)acrylic ester-based resin of which the glass transition temperature is comparatively low is first fluidized, and the fluidization affects the styrene-based resin, and thus, both of the resins are fluidized. In addition, when both of the resins in the pressure-responsive particles are fluidized by pressurization, and then, are solidified by depressurization to form a resin layer, it is considered that the phase-separated state is formed again due to low compatibility.

In the (meth)acrylic ester-based resin containing at least two types of (meth)acrylic ester as the polymerization component, the type of ester group bonded to a main chain is at least two types, and thus, it is assumed that an alignment degree of molecules in a solid state is low, and therefore, the fluidization is easily performed by the pressurization, compared to a homopolymer of (meth)acrylic ester. Therefore, it is assumed that the pressure-responsive particles described above are easily fluidized by pressure, that is, are easily subjected to the phase transition by pressure, compared to the pressure-responsive particles in which the (meth)acrylic ester-based resin is the homopolymer of (meth)acrylic ester.

Then, the (meth)acrylic ester-based resin containing at least two types of (meth)acrylic ester as the polymerization component has a low alignment degree of the molecules even at the time of being solidified again, and thus, it is assumed that phase separation with respect to the styrene-based resin becomes minute phase separation. It is assumed that the state of an adhesive surface with respect to the electrode that is an adherend has high homogeneousness and excellent adhesiveness, as the state of the phase separation between the styrene-based resin and the (meth)acrylic ester-based resin is minute. Therefore, it is assumed that the pressure-responsive particles described above have excellent adhesiveness, compared to the pressure-responsive particles in which the (meth)acrylic ester-based resin is the homopolymer of (meth)acrylic ester.

Hereinafter, a preferred aspect of the pressure-responsive particles will be described in detail.

In the following description, unless otherwise noted, the “pressure-responsive particles” indicate the “pressure-responsive particles that contain the styrene-based resin containing styrene and the vinyl monomer other than styrene as the polymerization component, and the (meth)acrylic ester-based resin containing at least two types of (meth)acrylic ester as the polymerization component, have at least two glass transition temperatures, and have a difference between the lowest glass transition temperature and the highest glass transition temperature of 30° C. higher”. In addition, in the following description, unless otherwise noted, the “styrene-based resin” indicates the “styrene-based resin containing styrene and the vinyl monomer other than styrene as the polymerization component”, and the “(meth)acrylic ester-based resin” indicates the “(meth)acrylic ester-based resin containing at least two types of (meth)acrylic ester as the polymerization component”.

As described above, it is preferable that the pressure-responsive particles contain at least the styrene-based resin and the (meth)acrylic ester-based resin. The pressure-responsive particles may contain a coloring agent, a mold-releasing agent, and the other additives.

It is preferable that in the pressure-responsive particles, the content of the styrene-based resin is larger than the content of the (meth)acrylic ester-based resin, from the viewpoint of maintaining the adhesiveness. The content of the styrene-based resin is preferably 55 mass % or more and 80 mass % or less, is more preferably 60 mass % or more and 75 mass % or less, and is even more preferably 65 mass % or more and 70 mass % or less, with respect to the total content of the styrene-based resin and the (meth)acrylic ester-based resin.

(Styrene-Based Resin)

It is preferable that the pressure-responsive particles contain the styrene-based resin containing styrene and the vinyl monomer other than styrene as the polymerization component.

A mass ratio of styrene to the entire polymerization component of the styrene-based resin is preferably 60 mass % or more, is more preferably 70 mass % or more, and is even more preferably 75 mass % or more, from the viewpoint of suppressing the fluidization of the pressure-responsive particles in a state of not being pressurized, and is preferably 95 mass % or less, is more preferably 90 mass % or less, and is even more preferably 85 mass % or less, from the viewpoint of forming the pressure-responsive particles to be easily subjected to the phase transition by pressure.

From the viewpoint of suppressing the fluidization of the pressure-responsive particles in a state of not being pressurized and the viewpoint of forming the pressure-responsive particles to be easily subjected to the phase transition by pressure, it is preferable that the mass ratio of styrene to the entire polymerization component of the styrene-based resin is 60 mass % or more and 95 mass % or less.

Examples of the vinyl monomer other than styrene, configuring the styrene-based resin, include a styrene-based monomer other than styrene, and an acrylic monomer.

Examples of the styrene-based monomer other than styrene include vinyl naphthalene; alkyl-substituted styrene such as a-methyl styrene, o-methyl styrene, m-methyl styrene, p-methyl styrene, p-ethyl styrene, 2,4-dimethyl styrene, p-n-butyl styrene, p-tert-butyl styrene, p-n-hexyl styrene, p-n-octyl styrene, p-n-nonyl styrene, p-n-decyl styrene, and p-n-dodecyl styrene; aryl-substituted styrene such as p-phenyl styrene; alkoxy-substituted styrene such as p-methoxystyrene; halogen-substituted styrene such as p-chlorostyrene, 3,4-dichlorostyrene, p-fluorostyrene, and 2,5-difluorostyrene; and nitro-substituted styrene such as m-nitrostyrene, o-nitrostyrene, and p-nitrostyrene. One type of such styrene-based monomers may be independently used, or two or more types thereof may be used together.

At least one acrylic monomer selected from the group consisting of a (meth)acrylic acid and (meth)acrylic ester is preferable as the acrylic monomer. Examples of (meth)acrylic ester include alkyl (meth)acrylic ester, carboxy-substituted alkyl (meth)acrylic ester, hydroxy-substituted alkyl (meth)acrylic ester, alkoxy-substituted alkyl (meth)acrylic ester, and di(meth)acrylic ester. One type of such acrylic monomers may be independently used, or two or more types thereof may be used together.

Examples of alkyl (meth)acrylic ester include methyl (meth)acrylate, ethyl (meth)acrylate, propyl (meth)acryl ate, isopropyl (meth)acrylate, n-butyl (meth)acrylate, isobutyl (meth)acrylate, n-hexyl (meth)acrylate, 2-ethyl hexyl (meth)acrylate, lauryl (meth)acrylate, stearyl (meth)acrylate, cyclohexyl (meth)acrylate, dicyclopentanyl (meth)acrylate, and isobornyl (meth)acrylate.

Examples of carboxy-substituted alkyl (meth)acrylic ester include 2-carboxyethyl (meth)acrylate.

Examples of hydroxy-substituted alkyl (meth)acrylic ester include 2-hydroxyethyl (meth)acrylate, 2-hydroxypropyl (meth)acrylate, 3 -hydroxypropyl (meth)acrylate, 2-hydroxybutyl (meth)acrylate, 3 -hydroxybutyl (meth)acrylate, and 4-hydroxybutyl (meth)acrylate.

Examples of alkoxy-substituted alkyl (meth)acrylic ester include 2-methoxyethyl (meth)acrylate.

Examples of di(meth)acrylic ester include ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate.

Examples of (meth)acrylic ester also include 2-(diethyl amino)ethyl (meth)acrylate, benzyl (meth)acrylate, and methoxypolyethylene glycol (meth)acrylate. Examples of the vinyl monomer other than styrene, configuring the styrene-based resin, also include (meth)acrylonitrile; vinyl ether such as vinyl methyl ether and vinyl isobutyl ether; vinyl ketone such as vinyl methyl ketone, vinyl ethyl ketone, and vinyl isopropenyl ketone; and olefin such as isoprene, butene, and butadiene, in addition to the styrene-based monomer and the acrylic monomer. The styrene-based resin preferably contains (meth)acrylic ester, more preferably contains alkyl (meth)acrylic ester, even more preferably contains alkyl (meth)acrylic ester in which the number of carbon atoms of an alkyl group is 2 or more and 10 or less, still even more preferably contains alkyl (meth)acrylic ester in which the number of carbon atoms of an alkyl group is 4 or more and 8 or less, and particularly preferably contains at least one of n-butyl acrylate and 2-ethyl hexyl acrylate, as the polymerization component, from the viewpoint of forming the pressure-responsive particles to be easily subjected to the phase transition by pressure. It is preferable that the styrene-based resin and the (meth)acrylic ester-based resin contain the same type of (meth)acrylic ester as the polymerization component, from the viewpoint of forming the pressure-responsive particles to be easily subjected to the phase transition by pressure.

A mass ratio of (meth)acrylic ester to the entire polymerization component of the styrene-based resin is preferably 40 mass % or less, is more preferably 30 mass % or less, and is even more preferably 25 mass % or less, from the viewpoint of suppressing the fluidization of the pressure-responsive particles in a state of not being pressurized, and is preferably 5 mass % or more, is more preferably 10 mass % or more, and is even more preferably 15 mass % or more, from the viewpoint of forming the pressure-responsive particles to be easily subjected to the phase transition by pressure. Here, as (meth)acrylic ester, alkyl (meth)acrylic ester is preferable, alkyl (meth)acrylic ester in which the number of carbon atoms of an alkyl group is 2 or more and 10 or less is more preferable, and alkyl (meth)acrylic ester in which the number of carbon atoms of an alkyl group is 4 or more and 8 or less is even more preferable.

It is particularly preferable that the styrene-based resin contains at least one of n-butyl acrylate and 2-ethyl hexyl acrylate as the polymerization component, and the total amount of n-butyl acrylate and 2-ethyl hexyl acrylate with respect to the entire polymerization component of the styrene-based resin is preferably 40 mass % or less, is more preferably 30 mass % or less, and is even more preferably 25 mass % or less, from the viewpoint of suppressing the fluidization of the pressure-responsive particles in a state of not being pressurized, and is preferably 5 mass % or more, is more preferably 10 mass % or more, and is even more preferably 15 mass % or more, from the viewpoint of forming the pressure-responsive particles to be easily subjected to the phase transition by pressure.

A weight average molecular weight of the styrene-based resin is preferably 3000 or more, is more preferably 4000 or more, and is even more preferably 5000 or more, from the viewpoint of suppressing the fluidization of the pressure-responsive particles in a state of not being pressurized, and is preferably 60000 or less, is more preferably 55000 or less, and is even more preferably 50000 or less, from the viewpoint of forming the pressure-responsive particles to be easily subjected to the phase transition by pressure.

In the disclosure, the weight average molecular weight (also noted as “Mw”) of the resin is measured by gel permeation chromatography (GPC). In molecular weight measurement of GPC, HLC-8120GPC manufactured by Tosoh Corporation is used as a GPC device, TSKgel SuperHM-M (15 cm) manufactured by Tosoh Corporation is used as a column, and tetrahydrofuran is used as a solvent. The weight average molecular weight of the resin is calculated by using a molecular weight calibration curve that is prepared by a monodisperse polystyrene reference sample.

A glass transition temperature of the styrene-based resin is preferably 30° C. or higher, is more preferably 40° C. or higher, is even more preferably 50° C. or higher, from the viewpoint of suppressing the fluidization of the pressure-responsive particles in a state of not being pressurized, and is preferably 110° C. or lower, is more preferably 100° C. or lower, and is even more preferably 90° C. or lower, from the viewpoint of forming the pressure-responsive particles to be easily subjected to the phase transition by pressure.

In the disclosure, the glass transition temperature of the resin is obtained from a differential scanning calorimetric curve (a DSC curve) that is obtained by performing differential scanning calorimetry (DSC). More specifically, the glass transition temperature is obtained in accordance with “Extrapolated Glass Transition Onset Temperature” described in a method for obtaining a glass transition temperature in JIS K7121:1987 “Testing Methods for Transition Temperatures of Plastics”.

The glass transition temperature of the resin may be controlled in accordance with the type of polymerization component and a polymerization ratio. The glass transition temperature tends to be low as the density of a flexible unit such as a methylene group, an ethylene group, and an oxyethylene group to be contained in the main chain is high, and tends to be high as the density of a rigid unit such as an aromatic ring and a cyclohexane ring to be contained in the main chain is high. In addition, the glass transition temperature tends to be low as the density of an aliphatic group in a side chain is high.

A mass ratio of the styrene-based resin to the entire pressure-responsive particles is preferably 55 mass % or more, is more preferably 60 mass % or more, is even more preferably 65 mass % or more, from the viewpoint of suppressing the fluidization of the pressure-responsive particles in a state of not being pressurized, and is preferably 80 mass % or less, is more preferably 75 mass % or less, and is even more preferably 70 mass % or less, from the viewpoint of forming the pressure-responsive particles to be easily subjected to the phase transition by pressure.

((Meth)Acrylic Ester-Based Resin)

It is preferable that the pressure-responsive particles contain the (meth)acrylic ester-based resin containing at least two types of (meth)acrylic ester as the polymerization component.

A mass ratio of (meth)acrylic ester to the entire polymerization component of the (meth)acrylic ester-based resin is preferably 90 mass % or more, is more preferably 95 mass % or more, is even more preferably 98 mass % or more, and is particularly preferably 100 mass %, from the viewpoint of forming the pressure-responsive particles having excellent adhesiveness.

Examples of (meth)acrylic ester include alkyl (meth)acrylic ester, carboxy-substituted alkyl (meth)acrylic ester, hydroxy-substituted alkyl (meth)acrylic ester, alkoxy-substituted alkyl (meth)acrylic ester, and di(meth)acrylic ester.

Examples of alkyl (meth)acrylic ester include methyl (meth)acrylate, ethyl (meth)acrylate, propyl (meth)acrylate, isopropyl (meth)acrylate, n-butyl (meth)acrylate, isobutyl (meth)acrylate, n-hexyl (meth)acrylate, 2-ethyl hexyl (meth)acrylate, lauryl (meth)acrylate, stearyl (meth)acrylate, cyclohexyl (meth)acrylate, dicyclopentanyl (meth)acrylate, and isobornyl (meth)acrylate.

Examples of carboxy-substituted alkyl (meth)acrylic ester include 2-carboxyethyl (meth)acrylate.

Examples of hydroxy-substituted alkyl (meth)acrylic ester include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Examples of alkoxy-substituted alkyl (meth)acrylic ester include 2-methoxyethyl (meth)acrylate.

Examples of di(meth)acrylic ester include ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate.

Examples of (meth)acrylic ester also include 2-(diethyl amino)ethyl (meth)acrylate, benzyl (meth)acrylate, and methoxypolyethylene glycol (meth)acrylate.

One type of such (meth)acrylic ester may be independently used, or two or more types thereof may be used together.

As (meth)acrylic ester, alkyl (meth)acrylic ester is preferable, alkyl (meth)acrylic ester in which the number of carbon atoms of an alkyl group is 2 or more and 10 or less is more preferable, alkyl (meth)acrylic ester in which the number of carbon atoms of an alkyl group is 4 or more and 8 or less is even more preferable, and n-butyl acrylate and 2-ethyl hexyl acrylate are particularly preferable, from the viewpoint of forming the pressure-responsive particles that are easily subjected to the phase transition by pressure and have excellent adhesiveness. It is preferable that the styrene-based resin and the (meth)acrylic ester-based resin contain the same type of (meth)acrylic ester as the polymerization component, from the viewpoint of forming the pressure-responsive particles to be easily subjected to the phase transition by pressure.

A mass ratio of alkyl (meth)acrylic ester to the entire polymerization component of the (meth)acrylic ester-based resin is preferably 90 mass % or more, is more preferably 95 mass % or more, is even more preferably 98 mass % or more, and is still even more preferably 100 mass %, from the viewpoint of forming the pressure-responsive particles that are easily subjected to the phase transition by pressure and have excellent adhesiveness. Here, as alkyl (meth)acrylic ester, alkyl (meth)acrylic ester in which the number of carbon atoms of an alkyl group is 2 or more and 10 or less is preferable, and alkyl (meth)acrylic ester in which the number of carbon atoms of an alkyl group is 4 or more and 8 or less is more preferable.

A mass ratio of two types having the highest mass ratio in at least two types of (meth)acrylic ester contained in the (meth)acrylic ester-based resin as the polymerization component is preferably 80:20 to 20:80, is more preferably 70:30 to 30:70, is even more preferably 60:40 to 40:60, from the viewpoint of forming the pressure-responsive particles that are easily subjected to the phase transition by pressure and have excellent adhesiveness.

It is preferable that the two types having the highest mass ratio in at least two types of (meth)acrylic ester contained in the (meth)acrylic ester-based resin as the polymerization component are alkyl (meth)acrylic ester. Here, as alkyl (meth)acrylic ester, alkyl (meth)acrylic ester in which the number of carbon atoms of an alkyl group is 2 or more and 10 or less is preferable, and alkyl (meth)acrylic ester in which the number of carbon atoms of an alkyl group is 4 or more and 8 or less is more preferable.

In a case where the two types having the highest mass ratio in at least two types of (meth)acrylic ester contained in the (meth)acrylic ester-based resin as the polymerization component are alkyl (meth)acrylic ester, a difference in number of carbon atoms of alkyl groups between the two types of alkyl (meth)acrylic ester is preferably 1 or more and 4 or less, is more preferably 2 or more and 4 or less, is even more preferably 3 or 4, from the viewpoint of forming the pressure-responsive particles that are easily subjected to the transition by pressure and have excellent adhesiveness.

It is preferable that the (meth)acrylic ester-based resin contains n-butyl acrylate and 2-ethyl hexyl acrylate as the polymerization component, and it is particularly preferable that the two types having the highest mass ratio two types in at least two types of (meth)acrylic ester contained in the (meth)acrylic ester-based resin as the polymerization component are n-butyl acrylate and 2-ethyl hexyl acrylate, from the viewpoint of forming the pressure-responsive particles that are easily subjected to the phase transition by pressure and have excellent adhesiveness. The total amount of n-butyl acrylate and 2-ethyl hexyl acrylate with respect to the entire polymerization component of the (meth)acrylic ester-based resin is preferably 90 mass % or more, is more preferably 95 mass % or more, is even more preferably 98 mass % or more, and is still even more preferably 100 mass %.

The (meth)acrylic ester-based resin may contain a vinyl monomer other than (meth)acrylic ester as the polymerization component. Examples of the vinyl monomer other than (meth)acrylic ester include a (meth)acrylic acid; styrene; a styrene-based monomer other than styrene; (meth)acrylonitrile; vinyl ether such as vinyl methyl ether and vinyl isobutyl ether; vinyl ketone such as vinyl methyl ketone, vinyl ethyl ketone, and vinyl isopropenyl ketone; and olefin such as isoprene, butene, and butadiene. One type of such vinyl monomers may be independently used, or two or more types thereof may be used together.

In a case where the (meth)acrylic ester-based resin contains the vinyl monomer other than (meth)acrylic ester as the polymerization component, as the vinyl monomer other than (meth)acrylic ester, at least one of an acrylic acid and a methacrylic acid is preferable, and an acrylic acid is more preferable.

A weight average molecular weight of the (meth)acrylic ester-based resin is preferably 100000 or more, is more preferably 120000 or more, is even more preferably 150000 or more, from the viewpoint of suppressing the fluidization of the pressure-responsive particles in a state of not being pressurized, and is preferably 250000 or less, is more preferably 220000 or less, and is even more preferably 200000 or less, from the viewpoint of forming the pressure-responsive particles to be easily subjected to the phase transition by pressure.

A glass transition temperature of the (meth)acrylic ester-based resin is preferably 10° C. or lower, is more preferably 0° C. or lower, and is even more preferably −10° C. or lower, from the viewpoint of forming the pressure-responsive particles to be easily subjected to the phase transition by pressure, and is preferably −90° C. or higher, is more preferably −80° C. or higher, and is even more preferably −70° C. or higher, from the viewpoint of suppressing the fluidization of the pressure-responsive particles in a state of not being pressurized.

A mass ratio of the (meth)acrylic ester-based resin to the entire pressure-responsive particles is preferably 20 mass % or more, is more preferably 25 mass % or more, and is even more preferably 30 mass % or more, from the viewpoint of forming the pressure-responsive particles to be easily subjected to the phase transition by pressure, and is preferably 45 mass % or less, is more preferably 40 mass % or less, and is even more preferably 35 mass % or less, from the viewpoint of suppressing the fluidization of the pressure-responsive particles in a state of not being pressurized.

The total amount of the styrene-based resin and the (meth)acrylic ester-based resin contained in the pressure-responsive particles is preferably 70 mass % or more, is more preferably 80 mass % or more, is even more preferably 90 mass % or more, is still even more preferably 95 mass % or more, and is further even more preferably 100 mass %, with respect to the entire pressure-responsive particles.

(Other Resins)

The pressure-responsive particles, for example, may contain polystyrene; an non-vinyl-based resin such as an epoxy resin, a polyester resin, a polyurethane resin, a polyamide resin, a cellulose resin, a polyether resin, and modified rosin; and the like. One type of such resins may be independently used, or two or more types thereof may be used together.

(Various Additives)

The pressure-responsive particles, as necessary, may contain a coloring agent (for example, a pigment and a dye), a mold-releasing agent (for example, hydrocarbon-based wax; natural wax such as carnauba wax, rice wax, and candelilla wax; synthetic wax or mineral or petroleum-based wax such as montan wax; and ester-based wax such as fatty ester and montanic acid ester), an electrification control agent, and the like.

In a case where the pressure-responsive particles are transparent pressure-responsive particles, it is preferable that the amount of coloring agent in the pressure-responsive particles is 1.0 mass % or less with respect to the entire pressure-responsive particles, and it is preferable that the amount of coloring agent is small from the viewpoint of increasing the transparency of the pressure-responsive particles.

(Structure of Pressure-Responsive Particles)

It is preferable that an internal structure of the pressure-responsive particles is a sea-island structure, and as the sea-island structure, a sea-island structure including a sea phase containing a styrene-based resin, and an island phase containing a (meth)acrylic ester-based resin, which is dispersed in the sea phase, is preferable. A specific form of the styrene-based resin contained in the sea phase is as described above. A specific form of the (meth)acrylic ester-based resin contained in the island phase is as described above. An island phase not containing the (meth)acrylic ester-based resin may be dispersed in the sea phase.

In a case where the pressure-responsive particles has the sea-island structure, it is preferable that an average diameter of the island phase is 200 nm or more and 500 nm or less. In a case where the average diameter of the island phase is 500 nm or less, the pressure-responsive particles are easily subjected to the phase transition by pressure, and in a case where the average diameter of the island phase is 200 nm or more, a mechanical strength required for the pressure-responsive particles (for example, a strength in which deformation is less likely to occur at the time of stirring the pressure-responsive particles in a developing device) is excellent. From such a viewpoint, the average diameter of the island phase is more preferably 220 nm or more and 450 nm or less, and is even more preferably 250 nm or more and 400 nm or less.

Examples of a method for controlling the average diameter of the island phase of the sea-island structure in the range described above include increasing or decreasing the amount of (meth)acrylic ester-based resin with respect to the amount of styrene-based resin, and increasing or decreasing a time for maintaining a high temperature in a step of fusing and coalescing aggregated resin particles, in a manufacturing method of pressure-responsive particles described below.

The check of the sea-island structure and the measurement of the average diameter of the island phase are performed by the following method.

The pressure-responsive particles are embedded in an epoxy resin, a segment is prepared by a diamond knife or the like, and the prepared segment is dyed in a desiccator by using osmium tetroxide or ruthenium tetroxide. The dyed segment is observed with an electron scanning microscope (SEM). The sea phase and the island phase of the sea-island structure are distinguished by a contrasting density due to a dyeing degree of the resin according to osmium tetroxide or ruthenium tetroxide, and by using this, the presence or absence of the sea-island structure is checked. 100 island phases are randomly selected from an SEM image, a long diameter of each of the island phases is measured, and an average value of 100 long diameters is set to the average diameter.

The pressure-responsive particles may be pressure-responsive base particles having a single-layer structure, or may be pressure-responsive particles having a core-shell structure including a core portion and a shell layer covering the core portion. It is preferable that the pressure-responsive particles have the core-shell structure, from the viewpoint of suppressing the fluidization of the pressure-responsive particles in a state of not being pressurized.

In a case where the pressure-responsive particles have the core-shell structure, the core portion contains a styrene-based resin and a (meth)acrylic ester-based resin, from the viewpoint that the phase transition is easily performed by pressure. Further, it is preferable that the shell layer contains a styrene-based resin, from the viewpoint of suppressing the fluidization of the pressure-responsive particles in a state of not being pressurized. A specific form of the styrene-based resin is as described above. A specific form of the (meth)acrylic ester-based resin is as described above.

In a case where the pressure-responsive particles have the core-shell structure, it is preferable that the core portion includes a sea phase containing a styrene-based resin, and an island phase containing a (meth)acrylic ester-based resin, which is dispersed in the sea phase. It is preferable that an average diameter of the island phase is in the range described above. Further, it is preferable that the core portion has the configuration described above, and the shell layer further contains a styrene-based resin. In this case, the sea phase of the core portion and the shell layer are connected, and thus, the pressure-responsive particles are easily subjected to the phase transition by pressure. A specific form of the styrene-based resin contained in the sea phase of the core portion and the shell layer is as described above. A specific form of the (meth)acrylic ester-based resin contained in the island phase of the core portion is as described above.

Examples of the resin contained in the shell layer include polystyrene; and a non-vinyl-based resin such as an epoxy resin, a polyester resin, a polyurethane resin, a polyamide resin, a cellulose resin, a polyether resin, and modified rosin. One type of such resins may be independently used, or two or more types thereof may be used together.

An average thickness of the shell layer is preferably 120 nm or more, is more preferably 130 nm or more, and is even more preferably 140 nm or more, from the viewpoint of suppressing the deformation of the pressure-responsive particles, and is preferably 550 nm or less, is more preferably 500 nm or less, and is even more preferably 400 nm or less, from the viewpoint that the pressure-responsive particles are easily subjected to the phase transition by pressure.

The average thickness of the shell layer is measured by the following method.

The pressure-responsive particles are embedded in an epoxy resin, a segment is prepared by a diamond knife or the like, and the prepared segment is dyed in a desiccator by using osmium tetroxide or ruthenium tetroxide. The dyed segment is observed with an electron scanning microscope (SEM). Sectional surfaces of 10 pressure-responsive particles are randomly selected from an SEM image, the thickness of the shell layer is measured in 20 sites per one pressure-responsive particle such that an average value is calculated, and an average value of 10 pressure-responsive particles is set to the average thickness. The volume average particle diameter (D50v) of the pressure-responsive particles is preferably 4 μm or more, is more preferably 5 μm or more, and is even more preferably 6 μm or more, from the viewpoint of the handleability of the pressure-responsive particles, and is preferably 12 μm or less, is more preferably 10 μm or less, and is even more preferably 9 μm or less, from the viewpoint that the entire pressure-responsive particles are easily subjected to the phase transition by pressure.

The volume average particle diameter (D50v) of the pressure-responsive particles is measured by using a Coulter Multisizer II (manufactured by Beckman Coulter, Inc.) and an aperture having an aperture diameter of 100 μm. 0.5 mg or more and 50 mg or less of pressure-responsive particles are added and dispersed into 2 mL of an aqueous solution of sodium alkylbenzene sulfonate of 5 mass %, and then, are mixed with 100 mL or more and 150 mL or less of an electrolytic solution (ISOTON-II, manufactured by Beckman Coulter, Inc.), and a dispersion treatment is performed with a ultrasonic disperser for 1 minute, and a dispersion liquid that is obtained is set to a sample. In the sample, a particle diameter of 50000 particles having a particle diameter of 2 μm or more and 60 μm or less is measured. A particle diameter corresponding to the cumulative percentage of 50% in a volume-based particle size distribution drawn from the side of the small diameter is defined as the volume average particle diameter (D50v).

(Preferred Characteristics of Pressure-Responsive Particles)

The pressure-responsive particles have at least two glass transition temperatures, one of the glass transition temperatures is assumed as the glass transition temperature of the styrene-based resin, and the other is assumed as the glass transition temperature of the (meth)acrylic ester-based resin.

The pressure-responsive particles may have three or more glass transition temperatures, and it is preferable that the number of glass transition temperatures is 2. Examples of a form in which the number of glass transition temperatures is 2 include a form in which the resin contained in the pressure-responsive particles is only a styrene-based resin and a (meth)acrylic ester-based resin; and a form in which the content of a resin other than the styrene-based resin and the (meth)acrylic ester-based resin is low (for example, a form in which the content of the resin other than the styrene-based resin and the (meth)acrylic ester-based resin is 5 mass % or less with respect to the entire pressure-responsive particles).

It is preferable that the pressure-responsive particles have at least two glass transition temperatures, and have a difference between the lowest glass transition temperature and the highest glass transition temperature of 30° C. or higher. The difference between the lowest glass transition temperature and the highest glass transition temperature is more preferably 40° C. or higher, is even more preferably 50° C. or higher, and is still even more preferably 60° C. or higher, from the viewpoint that the pressure-responsive particles are easily subjected to the phase transition by pressure. The upper limit of the difference between the lowest glass transition temperature and the highest glass transition temperature is preferably 140° C. or lower, is more preferably is 130° C. or lower, and is even more preferably 120° C. or lower.

The lowest glass transition temperature that is exhibited by the pressure-responsive particles is preferably 10° C. or lower, is more preferably 0° C. or lower, and is even more preferably −10° C. or lower, from the viewpoint that the pressure-responsive particles are easily subjected to the phase transition by pressure, and is preferably −90° C. or higher, is more preferably −80° C. or higher, and is even more preferably −70° C. or higher, from the viewpoint of suppressing the fluidization of the pressure-responsive particles in a state of not being pressurized.

The highest glass transition temperature that is exhibited by the pressure-responsive particles is preferably 30° C. or higher, is more preferably 40° C. or higher, and is even more preferably 50° C. or higher, from the viewpoint of suppressing the fluidization of the pressure-responsive particles in a state of not being pressurized, and is preferably 70° C. or lower, is more preferably 65° C. or lower, and is even more preferably 60° C. or lower, from the viewpoint that the pressure-responsive particles are easily subjected to the phase transition by pressure.

In the disclosure, the glass transition temperature of the pressure-responsive particles is obtained from a differential scanning calorimetric curve (a DSC curve) that is obtained by performing differential scanning calorimetry (DSC). More specifically, the glass transition temperature is obtained in accordance with “Extrapolated Glass Transition Onset Temperature” described in a method for obtaining a glass transition temperature in JIS K7121:1987 “Testing Methods for Transition Temperatures of Plastics”.

It is preferable that the pressure-responsive particles are pressure-responsive particles to be subjected to the phase transition by pressure, and it is preferable that the pressure-responsive particles satisfy Expression 1 described below.

10° C.≤T1−T2 Expression 1

In Expression 1, T1 is a temperature at which a viscosity of 10000 Pa·s is exhibited under a pressure of 1 MPa, and T2 is a temperature at which a viscosity of 10000 Pa·s is exhibited under a pressure of 10 MPa.

A temperature difference (T1−T2) is preferably 10° C. or higher, is more preferably 15° C. or higher, and is even more preferably 20° C. or higher, from the viewpoint that the pressure-responsive particles are easily subjected to the phase transition by pressure, and is preferably 120° C. or lower, is more preferably 100° C. or lower, and is even more preferably 80° C. or lower, from the viewpoint of suppressing the fluidization of the pressure-responsive particles in a state of not being pressurized.

The value of the temperature T1 is preferably 140° C. or lower, is more preferably 130° C. or lower, is even more preferably 120° C. or lower, and is still even more preferably 115° C. or lower. The lower limit of the temperature T1 is preferably 80° C. or higher, and is more preferably 85° C. or higher.

The value of the temperature T2 is preferably 40° C. or higher, is more preferably 50° C. or higher, and is even more preferably 60° C. or higher. The upper limit of the temperature T2 is preferably 85° C. or lower.

Examples of an index indicating that the pressure-responsive particles are easily subjected to the phase transition by pressure include temperature difference (T1−T3) between the temperature T1 at which a viscosity of 10000 Pa·s is exhibited under a pressure of 1 MPa and a temperature T3 at which a viscosity of 10000 Pa·s is exhibited under a pressure of 4 MPa, and it is preferable that the temperature difference (T1−T3) is 5° C. or higher. The temperature difference (T1−T3) is preferably 5° C. or higher, and is more preferably 10° C. or higher, from the viewpoint that the pressure-responsive particles are easily subjected to the phase transition by pressure.

A temperature difference (T1−T3) is generally 25° C. or lower.

In the pressure-responsive particles, the temperature T3 at which a viscosity of 10000 Pa·s is exhibited under a pressure of 4 MPa is preferably 90° C. or lower, is more preferably 85° C. or lower, and is even more preferably 80° C. or lower, from the viewpoint that the temperature difference (T1−T3) is 5° C. or higher. The lower limit of the temperature T3 is preferably 60° C. or higher.

A method for obtaining the temperature T1, the temperature T2, and the temperature T3 is as follows.

The pressure-responsive particles are compressed to prepare a pellet-shaped sample. The pellet-shaped sample is set in a flow tester (CFT-500, manufactured by SHIMADZU CORPORATION), an applied pressure is fixed to 1 MPa, and a viscosity with respect to a temperature at 1 MPa is measured. From a graph of the obtained viscosity, the temperature T1 when the viscosity is 10⁴ Pa·s at the applied pressure of 1 MPa is determined. The temperature T2 is determined by the same method as that of the temperature T1 except that the applied pressure is changed to 10 MPa from 1 MPa. The temperature T3 is determined by the same method as that of the temperature T1 except that the applied pressure is changed to 4 MPa from 1 MPa. The temperature difference (T1−T2) is calculated from the temperature T1 and the temperature T2. The temperature difference (T1−T3) is calculated from the temperature T1 and the temperature T3.

[Manufacturing Method of Pressure-Responsive Particles]

The pressure-responsive particles may be manufactured by any of a dry manufacturing method (for example, a kneading pulverization method and the like) and a wet manufacturing method (for example, an aggregation coalescence method, a suspension polymerization method, a dissolution suspension method, and the like). Such a manufacturing method is not particularly limited, and a known manufacturing method is adopted. Among them, it is preferable that the pressure-responsive particles are obtained by the aggregation coalescence method.

In a case where the pressure-responsive particles are manufactured by the aggregation coalescence method, for example, the pressure-responsive particles are manufactured through:
a step of preparing a styrene-based resin particle dispersion liquid in which styrene-based resin particles containing a styrene-based resin are dispersed (a styrene-based resin particle dispersion liquid preparing step);
a step of forming composite resin particles containing a styrene-based resin and a (meth)acrylic ester-based resin by polymerizing the (meth)acrylic ester-based resin in the styrene-based resin particle dispersion liquid (a composite resin particle forming step);
a step of forming aggregated particles by aggregating the composite resin particles in a composite resin particle dispersion liquid in which the composite resin particles are dispersed (an aggregated particle forming step); and
a step of forming pressure-responsive base particles by heating an aggregated particle dispersion liquid in which the aggregated particles are dispersed, and by fusing and coalescing the aggregated particles (a fusing and coalescing step).

Hereinafter, the details of each of the steps will be described.

In the following description, a method for obtaining pressure-responsive particles not containing a coloring agent and a mold-releasing agent will be described. The coloring agent, the mold-releasing agent, and other additives may be used, as necessary. In a case where the pressure-responsive particles contain the coloring agent and the mold-releasing agent, the composite resin particle dispersion liquid, a coloring agent particle dispersion liquid, and a mold-releasing agent particle dispersion liquid are mixed, and then, the fusing and coalescing step is performed. The coloring agent particle dispersion liquid and the mold-releasing agent particle dispersion liquid, for example, may be prepared by mixing materials, and then, performing a dispersion treatment with a known disperser.

-Styrene-Based Resin Particle Dispersion Liquid Preparing Step-

The styrene-based resin particle dispersion liquid is, for example, a dispersion liquid in which the styrene-based resin particles are dispersed in a dispersion medium with a surfactant.

Examples of the dispersion medium include an aqueous medium such as water and alcohols. One type of such dispersion medium may be independently used, or two or more types thereof may be used together.

Examples of the surfactant include an anionic surfactant such as a sulfuric ester salt system, a sulfonate system, a phosphoric ester system, and a soap system; a cationic surfactant such as an amine salt system and a quaternary ammonium salt system; and a non-ionic surfactant such as a polyethylene glycol system, an alkyl phenol ethylene oxide adduct system, and a polyhydric alcohol system. The non-ionic surfactant may be used together with the anionic surfactant or the cationic surfactant. Among them, the anionic surfactant is preferable. One type of such surfactants independently used, or two or more types thereof may be used together.

Examples of a method for dispersing the styrene-based resin particles in the dispersion medium include a method for mixing the styrene-based resin and the dispersion medium, and performing stirring and dispersion with a rotational shear type homogenizer, a ball mill having media, a sand mill having media, and a dyno mill having media, or the like.

Examples of another method for dispersing the styrene-based resin particles in the dispersion medium include an emulsion polymerization method. Specifically, a polymerization component of the styrene-based resin, and a chain transfer agent or a polymerization initiator are mixed, and then, an aqueous medium containing a surfactant is further mixed and is stirred such that an emulsified liquid is prepared, and the styrene-based resin is polymerized in the emulsified liquid. At this time, it is preferable that dodecanethiol is used as the chain transfer agent.

A volume average particle diameter of the styrene-based resin particles dispersed in the styrene-based resin particle dispersion liquid is preferably 100 nm or more and 250 nm or less, is more preferably 120 nm or more and 220 nm or less, and is even more preferably 150 nm or more and 200 nm or less.

As a volume average particle diameter of the resin particles contained in the resin particle dispersion liquid, a particle diameter is measured with a laser diffraction particle size distribution measurement device (for example, LA-700, manufactured by HORIBA, Ltd.), and a particle diameter corresponding to the cumulative percentage of 50% in a volume-based particle size distribution drawn from the side of the small diameter is defined as the volume average particle diameter (D50v).

The content of the styrene-based resin particles contained in the styrene-based resin particle dispersion liquid is preferably 30 mass % or more and 60 mass % or less, and is more preferably 40 mass % or more and 50 mass % or less.

-Composite Resin Particle Forming Step-

The styrene-based resin particle dispersion liquid and a polymerization component of the (meth)acrylic ester-based resin are mixed, and the (meth)acrylic ester-based resin is polymerized in the styrene-based resin particle dispersion liquid, and thus, the composite resin particles containing the styrene-based resin and the (meth)acrylic ester-based resin are formed.

It is preferable that the composite resin particles are resin particles in which the styrene-based resin and the (meth)acrylic ester-based resin are contained in a microphase-separated state. The resin particles can be manufactured by the following method, for example.

The polymerization component of the (meth)acrylic ester-based resin (that is, a monomer group containing at least two types of (meth)acrylic ester) is added to the styrene-based resin particle dispersion liquid, and as necessary, the aqueous medium is added. Next, the temperature of the dispersion liquid is increased to a temperature higher than the glass transition temperature of the styrene-based resin (for example, a temperature of 10° C. to 30° C. higher than the glass transition temperature of the styrene-based resin) while the dispersion liquid is slowly stirred. Next, an aqueous medium containing a polymerization initiator is slowly dropped while the temperature is retained, and is continuously stirred for a long period of time in a range of 1 hour or longer and 15 hours or shorter. At this time, it is preferable that ammonium persulfate is used as the polymerization initiator.

The detailed mechanism is not apparent, but in the case of adopting the method described above, it is assumed that the monomer and the polymerization initiator are impregnated in the styrene-based resin particles, and (meth)acrylic ester is polymerized inside the styrene-based resin particles. Accordingly, it is assumed that the composite resin particles are obtained in which the (meth)acrylic ester-based resin is contained inside the styrene-based resin particles, and the styrene-based resin and the (meth)acrylic ester-based resin form a microphase-separated state inside the particles.

A volume average particle diameter of the composite resin particles dispersed in the composite resin particle dispersion liquid is preferably 140 nm or more and 300 nm or less, is more preferably 150 nm or more and 280 nm or less, is even more preferably 160 nm or more and 250 nm or less.

The content of the composite resin particles contained in the composite resin particle dispersion liquid is preferably 20 mass % or more and 50 mass % or less, and is more preferably 30 mass % or more and 40 mass % or less.

-Aggregated Particle Forming Step-

The composite resin particles are aggregated in the composite resin particle dispersion liquid, and thus, the aggregated particles having a diameter close to that of aimed pressure-responsive particles are formed.

Specifically, for example, an aggregating agent is added to the composite resin particle dispersion liquid, and the pH of the composite resin particle dispersion liquid is adjusted to be acidic (for example, pH of 2 or higher and 5 or lower), and as necessary, a dispersion stabilizer is added, and then, heating is performed to a temperature close to the glass transition temperature of the styrene-based resin (specifically, for example, the glass transition temperature of the styrene-based resin −30° C. or higher and the glass transition temperature of the styrene-based resin −10° C. or lower), the composite resin particles are aggregated, and thus, the aggregated particles are formed.

In the aggregated particle forming step, an aggregating agent may be added at a room temperature (for example, 25° C.) while the composite resin particle dispersion liquid is stirred with a rotational shear type homogenizer, the pH of the composite resin particle dispersion liquid may be adjusted to be acidic (for example, pH of 2 or higher and 5 or lower), and as necessary, a dispersion stabilizer may be added, and then, heating may be performed.

Examples of the aggregating agent include a surfactant having polarity reverse to that of the surfactant contained in the composite resin particle dispersion liquid, an inorganic metal salt, and a divalent or higher metal complex. In a case where a metal complex is used as the aggregating agent, a use amount of the surfactant is reduced, and electrification characteristics are improved.

An additive forming a complex or a similar bond with a metal ion of the aggregating agent may be used as necessary, along with the aggregating agent. A chelating agent is preferably used as the additive.

Examples of the inorganic metal salt include a metal salt such as calcium chloride, calcium nitrate, barium chloride, magnesium chloride, zinc chloride, aluminum chloride, and aluminum sulfate; and an inorganic metal salt polymer such as polyaluminum chloride, polyaluminum hydroxide, and calcium polysulfide.

A water-soluble chelating agent may be used as the chelating agent. Examples of the chelating agent include an oxycarboxylic acid such as a tartaric acid, a citric acid, and a gluconic acid; and an aminocarboxylic acid such as an iminodiacetic acid (IDA), a nitrilotriacetic acid (NTA), and an ethylenediaminetetraacetic acid (EDTA).

An additive amount of the chelating agent is preferably 0.01 parts by mass or more and 5.0 parts by mass or less, is more preferably 0.1 parts by mass or more and less than 3.0 parts by mass, with respect to 100 parts by mass of the resin particles.

-Fusing and Coalescing Step-

Next, the aggregated particle dispersion liquid in which the aggregated particles are dispersed are heated to, for example, a temperature higher than the glass transition temperature of the styrene-based resin (for example, a temperature of 10° C. to 30° C. higher than the glass transition temperature of the styrene-based resin), and the aggregated particles are fused and coalesced, and thus, the pressure-responsive particles are formed.

In general, the pressure-responsive particles obtained through the steps described above have a sea-island structure including a sea phase containing a styrene-based resin, and an island phase containing a (meth)acrylic ester-based resin, which is dispersed in the sea phase. It is assumed that in the composite resin particles, the styrene-based resin and the (meth)acrylic ester-based resin are in a microphase-separated state, but in the fusing and coalescing step, the styrene-based resins are collected together to be the sea phase, and the (meth)acrylic ester-based resins are collected together to be the island phase.

An average diameter of the island phase of the sea-island structure may be controlled by, for example, increasing or decreasing the amount of styrene-based resin particle dispersion liquid used in the composite resin particle forming step or the amount of at least two types of (meth)acrylic ester used in the composite resin particle forming step, or by increasing or decreasing a time for maintaining a high temperature in the fusing and coalescing step.

The pressure-responsive particles having a core-shell structure are manufactured through, for example:
a step of forming second aggregated particles by obtaining the aggregated particle dispersion liquid, and then, further mixing the aggregated particle dispersion liquid and the styrene-based resin particle dispersion liquid, and performing aggregation such that the styrene-based resin particles are further attached to the surface of the aggregated particles; and
a step of forming the pressure-responsive particles having a core-shell structure by heating a second aggregated particle dispersion liquid in which the second aggregated particles are dispersed, and fusing and coalescing the second aggregated particles.

The pressure-responsive particles having a core-shell structure obtained through the steps described above include a shell layer containing a styrene-based resin. A resin particle dispersion liquid in which resin particles other than styrene-based resin particles are dispersed may be used instead of the styrene-based resin particle dispersion liquid, and a shell layer containing resins other than the styrene-based resin may be formed.

After the fusing and coalescing step is ended, the pressure-responsive particles formed in a solution are subjected to a known washing step, a known solid-liquid separation step, and a known drying step, and thus, the pressure-responsive particles in a dried state are obtained. In the washing step, displacement washing of ion exchange water may be sufficiently performed from the viewpoint of electrification properties. In the solid-liquid separation step, suction filtration, pressure filtration, and the like may be performed from the viewpoint of productivity. In the drying step, freeze drying, flash drying, fluidized drying, vibration-type fluidized drying, and the like may be performed from the viewpoint of the productivity.

(External Addition)

As described above, an external additive may be externally added to the pressure-responsive particles, as necessary.

For example, the external additive is added to the obtained pressure-responsive particles in a dry state, and is mixed, and thus, the external addition of the external additive is performed. The mixing may be performed with, for example, a V blender, a Henschel mixer, a Loedige mixer, and the like. Further, as necessary, coarse particles may be removed with a vibration sieving machine, a wind sieving machine, or the like.

-External Additive-

Examples of the external additive with respect to the pressure-responsive particles include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of the inorganic particles as the external additive may be subjected to a hydrophobic treatment.

In addition, examples of the external additive include resin particles (for example, resin particles such as polystyrene, polymethyl methacrylate, and a melamine resin), and a cleaning activator (for example, particles of a metal salt of a higher fatty acid represented by zinc stearate, and a fluorine-based high-molecular weight body).

The total external additive amount of the external additive is preferably 1.0 part by mass or more and 20.0 parts by mass or less, is more preferably 1.0 part by mass or more and 10.0 parts by mass or less, is even more preferably 2.5 parts by mass or more and 7.0 parts by mass or less, with respect to 100 parts by mass of the pressure-responsive particles.

[Polyimide Porous Film]

The separator according to the present exemplary embodiment includes the polyimide porous film.

It is preferable that the polyimide porous film includes a plurality of pores for ion movement, and most of the plurality of pores are connected to each other, and thus, a state in which both surfaces of the polyimide porous film are communicated with each other is formed.

Hereinafter, first, preferred physical properties of the polyimide porous film will be described.

(Porosity and Air Permeance)

It is preferable that the polyimide porous film of the present exemplary embodiment has a porosity of 50% or more and 90% or less and an air permeance of 5 seconds/100 mL or more and 100 seconds/100 mL or less, from the viewpoint of improving the cycle characteristics.

The porosity of the polyimide porous film is preferably 50% or more and 90% or less, and is more preferably 55% or more and 85% or less.

The porosity of the polyimide porous film is obtained from an apparent density and a true density of the polyimide porous film.

An apparent density d is a value obtained by dividing the mass (g) of the polyimide porous film by the volume (cm³) of the polyimide porous film including the pores. The apparent density d may be obtained by dividing the mass (g/m²) of the polyimide porous film per unit area by the thickness (μm) of the polyimide porous film. A true density p is a value obtained by dividing the mass (g) of the polyimide porous film by the volume (cm³) of the polyimide porous film excluding the pores (that is, the volume only of a skeleton portion of the resin).

The porosity of the polyimide porous film is calculated by Expression 2 described below.

Porosity (%)={1−(d/p)}×100=[1−{(w/t)/ρ}]×100 Expression 2
d: Apparent Density (g/cm³) of Polyimide Porous Film
p: True Density (g/cm³) of Polyimide Porous Film
w: Mass (g/m²) of Polyimide Porous Film per Unit Area
t: Thickness (μm) of Polyimide Porous Film

The air permeance of the polyimide porous film is preferably 5 seconds/100 mL or more and 100 seconds/100 mL or less, and is more preferably 5 seconds/100 mL or more and 80 seconds/100 mL or less.

The air permeance of the polyimide porous film is measured by a Gurley type (JIS P 8117:2009) air permeance test method.

(Average Pore Diameter)

An average pore diameter of the polyimide porous film is preferably 50 nm or more and 1500 nm or less, and is more preferably 50 nm or more 1000 nm or less, from the viewpoint of improving the cycle characteristics.

The average pore diameter of the polyimide porous film is obtained from a value that is obtained by observing and measuring the sectional surface of the polyimide porous film in a thickness direction with an electron scanning microscope (SEM). Note that, the pores of the polyimide porous film are connected to each other, but the pore diameter is obtained by regarding each of the pores as an independent pore.

Here, the observation and the measurement of the electron scanning microscope (SEM) will be described in detail.

First, the polyimide porous film is cut out in the thickness direction, and a measurement sample having the cut surface as a measurement surface is prepared. Then, the measurement sample is observed and measured with VE SEM, manufactured by KEYENCE CORPORATION, and image processing software included in the VE SEM as standard. The measurement of a long diameter and a short diameter of the pore is performed with respect to 100 pores on the sectional surface of the measurement sample.

Here, the long diameter of the pore indicates the length of a long side of a circumscribed rectangle of the pore, and the short diameter of the pore indicates the length of a short side of the circumscribed rectangle of the pore.

An average value of the long diameters of 100 pores is set to the “average pore diameter” of the present exemplary embodiment.

(Average Flatness)

An average flatness of the polyimide porous film is preferably 0.1 or more and 0.7 or less, is more preferably 0.2 or more and 0.7 or less, and is even more preferably 0.2 or more and 0.6 or less, from the viewpoint of improving the strength of the film.

In the average flatness of the polyimide porous film, a flatness is obtained from Expression 3 described below, on the basis of the values of the long diameter and the short diameter, obtained by the measurement described above. Then, an average value of the flatnesses of 100 pores is set to the “average flatness” of the present exemplary embodiment.

Flatness=(Long Diameter−Short Diameter)/Long Diameter Expression 3

(Tensile Breaking Strength)

A tensile breaking strength of the polyimide porous film is caused by the strength of a polyimide resin, and thus, is preferably 10 MPa or more, and is more preferably 15 MPa or more.

In particular, it is preferable that the tensile breaking strength described above is attained in a polyimide porous film having a porosity in a range of 50% or more and 90% or less.

The tensile breaking strength of the polyimide porous film is measured as follows.

First, a strip-shaped measurement sample having a width of 5 mm, a length of 100 mm, and a thickness of 100 μm is prepared.

The strip-shaped measurement sample is pulled by using STROGRAPH VE-1D (manufactured by Toyo Seiki Seisaku-sho, Ltd.) in the following conditions, and a tensile breaking strength is calculated from a stress (that is, Load/Sectional Area) in fracture of the measurement sample.
Distance between Chucks: 50 mm
Pulling Speed: 500 mm/minute
Temperature: 23° C.
Relative Humidity: 55%

(Average Film Thickness)

An average film thickness of the polyimide porous film is not particularly limited, and is selected according to the application.

The average film thickness of the polyimide porous film may be, for example, 10 μm or more and 1000 μm or less. The average film thickness of the polyimide porous film may be 20 μm or more, or may be 30 μm or more. In addition, the average film thickness of the polyimide porous film may be 500 μm or less, or may be 400 μm or less.

The average film thickness of the polyimide porous film is obtained by observing 10 sites on the sectional surface in the thickness direction with an electron scanning microscope (SEM), by measuring a film thickness in each observation site from 10 SEM images, and by averaging obtained 10 measurement values of film thicknesses.

(Manufacturing Method of Polyimide Porous Film)

It is preferable that the polyimide porous film is manufactured through, for example, the following steps.

That is, a step of forming a film containing a polyimide precursor and resin particles by applying a polyimide precursor solution containing a polyimide precursor, particles, and a solvent onto a substrate to form a coated film, and then, drying the coated film (hereinafter, also referred to as a first step), a step of removing the particles from the film (hereinafter, also referred to as a second step), and a step of imidizing the polyimide precursor in the film by heating the film (hereinafter, also referred to as a third step) are exemplified.

Hereinafter, each of the steps will be described.

[First Step]

In the first step, the polyimide precursor solution containing the polyimide precursor, the resin particles, and the solvent is applied onto the substrate to form the coated film, and then, the coated film is dried, and thus, the film containing the polyimide precursor and the resin particles is formed.

[Polyimide Precursor Solution]

(Polyimide Precursor)

The polyimide precursor solution used in the first step contains the polyimide precursor.

It is preferable that the polyimide precursor is a resin having a repeating unit represented by the following general formula (I).

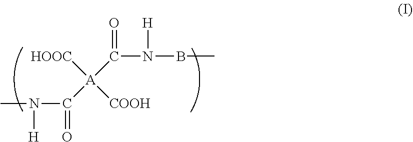

In the general formula (I), A represents a tetravalent organic group, and B represents a divalent organic group.

Here, in the general formula (I), the tetravalent organic group represented by A is a residue obtained by removing four carboxyl groups from a tetracarboxylic dianhydride as a raw material.

On the other hand, the divalent organic group represented by B is a residue obtained by removing two amino groups from a diamine compound as a raw material.

That is, the polyimide precursor having a repeating unit represented by the general formula (I) is a polymer of a tetracarboxylic dianhydride and a diamine compound.

Examples of the tetracarboxylic dianhydride include both an aromatic compound and an aliphatic compound, and the aromatic compound is preferred. That is, in the general formula (I), the tetravalent organic group represented by A is preferably an aromatic organic group.

Examples of an aromatic tetracarboxylic dianhydride include a pyromellitic dianhydride, a 3,3′,4,4′-benzophenone tetracarboxylic dianhydride, a 3,3′,4,4′-biphenyl sulfone tetracarboxylic dianhydride, a 1,4,5,8-naphthalene tetracarboxylic dianhydride, a 2,3,6,7-naphthalene tetracarboxylic dianhydride, a 3,3′,4,4′-biphenyl ether tetracarboxylic dianhydride, a 3,3′,4,4′-dimethyl diphenyl silane tetracarboxylic dianhydride, a 3,3′,4,4′-tetraphenyl silane tetracarboxylic dianhydride, a 1,2,3,4-furane tetracarboxylic dianhydride, a 4,4′-bis(3,4-dicarboxyphenoxy)diphenyl sulfide dianhydride, a 4,4′-bis(3,4-dicarboxyphenoxy)diphenyl sulfone dianhydride, a 4,4′-bis(3,4-dicarboxyphenoxy)diphenyl propane dianhydride, a 3,3′,4,4′-perfluoroisopropylidene diphthalic dianhydride, a 3,3′,4,4′-biphenyl tetracarboxylic dianhydride, a 2,3,3′,4′-biphenyl tetracarboxylic dianhydride, a bis(phthalic) phenyl phosphine oxide dianhydride, a p-phenylene-bis(triphenyl phthalic) dianhydride, an m-phenylene-bis(triphenyl phthalic) dianhydride, a bis(triphenyl phthalic)-4,4′-diphenyl ether dianhydride, and a bi s(triphenyl phthalic)-4,4′-diphenyl methane dianhydride. Examples of an aliphatic tetracarboxylic dianhydride include an aliphatic or alicyclic tetracarboxylic dianhydride such as a butane tetracarboxylic dianhydride, a 1,2,3,4-cyclobutane tetracarboxylic dianhydride, a 1,3 -dimethyl-1,2,3,4-cyclobutane tetracarboxylic dianhydride, a 1,2,3,4-cyclopentane tetracarboxylic dianhydride, a 2,3,5-tricarboxycyclopentyl acetic dianhydride, a 3,5,6-tricarboxynorbornane-2-acetic dianhydride, a 2,3,4,5-tetrahydrofuran tetracarboxylic dianhydride, a 5-(2,5-dioxotetrahydrofuryl)-3-methyl-3-cyclohexene-1,2-dicarboxylic di anhydride, and a bicyclo[2,2,2]-octo-7-ene-2,3,5,6-tetracarboxylic dianhydride; and an aliphatic tetracarboxylic dianhydride having an aromatic ring, such as 1,3,3a,4,5,9b-hexahydro-2,5-dioxo-3 -furanyl)-naphtho[1,2-c]furane-1,3 -dione, 1,3,3a,4,5,9b-hexahydro-5-methyl-5 -(tetrahydro-2,5-dioxo-3-furanyl)-naphtho[1,2-c]furane-1, 3-dione, and 1,3,3a,4,5,9b-hexahydro-8-methyl-5-(tetrahydro-2,5-dioxo-3-furanyl)-naphtho[1,2-c]furane-1, 3-dione.

Among them, the tetracarboxylic dianhydride is preferably an aromatic tetracarboxylic dianhydride, and specifically, for example, is preferably a pyromellitic dianhydride, a 3,3′,4,4′-biphenyl tetracarboxylic dianhydride, a 2,3,3′,4′-biphenyl tetracarboxylic dianhydride, a 3,3′,4,4′-biphenyl ether tetracarboxylic dianhydride, and a 3,3′,4,4′-benzophenone tetracarboxylic dianhydride, is more preferably a pyromellitic dianhydride, a 3,3′,4,4′-biphenyl tetracarboxylic dianhydride, and a 3,3′,4,4′-benzophenone tetracarboxylic dianhydride, and is particularly preferably a 3,3′,4,4′-biphenyl tetracarboxylic dianhydride.

Note that, one type of such tetracarboxylic dianhydrides may be independently used, or two or more types thereof may be used together by being combined.

In addition, in a case where two or more types of the tetracarboxylic dianhydrides are used together by being combined, an aromatic tetracarboxylic dianhydride and an aliphatic tetracarboxylic acid may be respectively used together, or an aromatic tetracarboxylic dianhydride and an aliphatic tetracarboxylic dianhydride may be combined.

On the other hand, the diamine compound is a diamine compound having two amino groups in a molecular structure. Examples of the diamine compound include either an aromatic compound or an aliphatic compound, and the diamine compound is preferably the aromatic compound. That is, in the general formula (I), the divalent organic group represented by B is preferably an aromatic organic group.

Examples of the diamine compound include aromatic diamine such as p-phenylene diamine, m-phenylene diamine, 4,4′-diaminodiphenyl methane, 4,4′-diaminodiphenyl ethane, 4,4′-diaminodiphenyl ether, 4,4′-diaminodiphenyl sulfide, 4,4′-diaminodiphenyl sulfone, 1,5-diaminonaphthalene, 3,3 -dimethyl-4,4′-di aminobiphenyl, 5-amino-1-(4′-aminophenyl)-1,3,3-trimethyl indane, 6-amino-1-(4′-aminophenyl)-1,3,3-trimethyl indane, 4,4′-diaminobenzanilide, 3,5-diamino-3′-trifluoromethyl benzanilide, 3,5 -diamino-4′-trifluoromethyl benzanilide, 3,4′-diaminodiphenyl ether, 2,7-diaminofluorene, 2,2-bis(4-aminophenyl) hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-di amino-2,2′-bi s(trifluoromethyl) biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl) fluorene, 4,4′-(p-phenylene isopropylidene) bisaniline, 4,4′-(m-phenylene isopropylidene) bisaniline, 2,2′-bis[4-(4-amino-2-trifluoromethyl phenoxy)phenyl] hexafluoropropane, and 4,4′-bi s[4-(4-amino-2-trifluoromethyl) phenoxy]-octafluorobiphenyl; aromatic diamine having two amino groups bonded to an aromatic ring and a hetero atom other than a nitrogen atom of the amino group, such as diaminotetraphenyl thiophene; and aliphatic diamine and alicyclic diamine such as 1,1-meta-xylylene diamine, 1,3-propane diamine, tetramethylene diamine, pentamethylene diamine, octamethylene diamine, nonamethylene diamine, 4,4-diaminoheptamethylene diamine, 1,4-diaminocyclohexane, isophorone diamine, tetrahydrodicyclopentadienylene diamine, hexahydro-4,7-methanoindanylene dimethyl ene diamine, tricyclo[6,2,1,0^{2,7}]-undecylene dimethyl diamine, and 4,4′-methylene bis(cyclohexyl amine).

Among them, the diamine compound is preferably an aromatic diamine compound, and specifically, for example, is preferably p-phenylene diamine, m-phenylene diamine, 4,4′-diaminodiphenyl methane, 4,4′-diaminodiphenyl ether, 3,4′-diaminodiphenyl ether, 4,4′-diaminodiphenyl sulfide, and 4,4′-diaminodiphenyl sulfone, and is particularly preferably 4,4′-diaminodiphenyl ether and p-phenylene diamine.

Note that, one type of such diamine compounds may be independently used, or two or more types thereof may be used together by being combined. In addition, in a case where two or more types of the diamine compounds are used together by being combined, an aromatic diamine compound and an aliphatic diamine compound may be respectively used together, or an aromatic diamine compound and an aliphatic diamine compound may be combined.

A weight average molecular weight of the polyimide precursor used in the present exemplary embodiment is preferably 5000 or more and 300000 or less, and is more preferably 10000 or more and 150000 or less.

The weight average molecular weight of the polyimide precursor is measured by a gel permeation chromatography (GPC) method in the following measurement conditions.
Column: TSKgela-M (7.8 mm I.D×30 cm) manufactured by Tosoh Corporation
Eluent: Dimethyl Formamide (DMF)/30 mM of LiBr/60 mM of Phosphoric Acid
Flow Rate: 0.6 mL/min
Injection Amount: 60 μL
Detector: RI (Differential Refractive Index Detector)

In the present exemplary embodiment, the content of the polyimide precursor is preferably 0.1 mass % or more and 40 mass % or less, and is more preferably 1 mass % or more and 25 mass % or less, with respect to the total mass of the polyimide precursor solution.

(Particles)

The polyimide precursor solution used in the first step contains particles.

It is preferable that the particles are dispersed in the polyimide precursor solution without being dissolved, from the viewpoint of forming the pores.

Note that, the material of the particles is not particularly limited insofar as the particles are not dissolved in the polyimide precursor solution.

Here, in the present exemplary embodiment, “the particles are not dissolved” indicates that not only the particles are not dissolved with respect to a target liquid (specifically, the solvent contained in the polyimide precursor solution) at 25° C., but also the particles are dissolved with respect to the target liquid in a range of 3 mass % or less.

The particles are broadly divided into resin particles and inorganic particles, and any of such particles may be used, but the resin particles are preferable from the viewpoint of excellent removal properties of the particles in the second step described below.

-Resin Particles-

The resin particles are not particularly limited insofar as the particles are not dissolved in the polyimide precursor solution (specifically, the solvent contained in the polyimide precursor solution). In consideration of the removal properties of the particles in the second step described below, resin particles containing a resin other than polyimide is preferable.

Examples of the resin particles include resin particles obtained by performing polycondensation with respect to a polymerizable monomer, such as a polyester resin and an urethane resin, and resin particles obtained by performing addition polymerization (specifically, radical addition polymerization) with respect to a polymerizable monomer, such as a vinyl resin, an olefin resin, and a fluorine resin.

Among them, a vinyl resin is preferable as the resin particles, and specifically, at least one selected from the group consisting of a (meth)acrylic resin, a (meth)acrylic ester resin, a styrene (meth)acrylic resin, and a polystyrene resin is preferable as the resin particles.

In addition, the resin particles may be crosslinked, or may not be crosslinked.

In addition, it is preferable that the resin particles are used as, for example, a resin particle dispersion liquid containing resin particles obtained by emulsion polymerization or the like, from the viewpoint of simplifying steps for manufacturing a polyimide precursor solution.

Here, in the present exemplary embodiment, “(meth)acryl” indicates that (meth)acryl may be either “acryl” or “methacryl”.

In a case where the resin particles contain a vinyl resin, examples of a monomer used to obtain the vinyl resin include the following monomers.

Examples of the monomer used to obtain the vinyl resin include styrenes having a styrene skeleton, such as styrene, alkyl-substituted styrene (for example, a-methyl styrene, 2-methyl styrene, 3-methyl styrene, 4-methyl styrene, 2-ethyl styrene, 3-ethyl styrene, 4-ethyl styrene, and the like), halogen-substituted styrene (for example, 2-chlorostyrene, 3-chlorostyrene, 4-chlorostyrene, and the like), and vinyl naphthalene; esters having a vinyl group (also referred to as (meth)acrylic esters), such as methyl (meth)acrylate, ethyl (meth)acrylate, n-propyl (meth)acrylate, n-butyl (meth)acrylate, lauryl (meth)acrylate, and 2-ethyl hexyl (meth)acrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as a (meth)acrylic acid, a maleic acid, a cinnamic acid, a fumaric acid, and a vinyl sulfonic acid; and bases such as ethylene imine, vinyl pyridine, and vinyl amine.

As a monomer other than the monomers described above, a monofunctional monomer such as vinyl acetate, a difunctional monomer such as ethylene glycol dimethacrylate, nonane diacrylate, and decanediol diacrylate, and a polyfunctional monomer such as trimethylol propane triacrylate and trimethylol propane trimethacrylate may be used together.

In addition, the vinyl resin may be a resin using such monomers independently, or may be a resin that is a copolymer using two or more types of the monomers.

In a case where the resin particles contain the vinyl resin, a vinyl resin obtained by using styrene as a monomer is preferable. In the vinyl resin obtained by using styrene, a ratio of styrene to the entire monomer component is preferably 20 mass % or more and 100 mass % or less, and is more preferably 40 mass % or more and 100 mass % or less.

That is, in the vinyl resin, the content of a constituent unit derived from styrene is preferably 20 mass % or more and 100 mass % or less, and is more preferably 40 mass % or more and 100 mass % or less, with respect to the mass of the vinyl resin.

An average particle diameter, the shape, and the like of the resin particles are not particularly limited, and may be suitably determined in accordance with the size and/or the shape of an aimed pore.

Examples of a volume average particle diameter of the resin particles include a range of 0.03 μm or more and 3.0 μm or less. The volume average particle diameter of the resin particles is preferably 0.04 μm or more, is more preferably 0.05 μm or more, and is even more preferably 0.07 μm or more. In addition, the volume average particle diameter of the resin particles is preferably 2.50 μm or less, is more preferably 2.45 μm or less, and is even more preferably 2.40 μm or less.

Regarding the average particle diameter of the resin particles, a cumulative distribution by volume is drawn from the side of the smallest diameter with respect to particle diameter ranges (so-called channels) separated using the particle diameter distribution obtained by the measurement of a laser diffraction-type particle diameter distribution measurement device (for example, Coulter Counter LS13, manufactured by Beckman Coulter, Inc.), and a particle diameter corresponding to the cumulative percentage of 50% with respect to the entire particles is set as a volume average particle diameter D₅₀ᵥ.

-Inorganic Particles-

Specifically, examples of the inorganic particles include inorganic particles such as silica (silicon dioxide) particles, magnesium oxide particles, alumina particles, zirconia particles, calcium carbonate particles, calcium oxide particles, titanium dioxide particles, zinc oxide particles, and cerium oxide particles. As described above, the shape of the particles is preferably nearly spherical particles. From such a viewpoint, inorganic particles such as silica particles, magnesium oxide particles, calcium carbonate particles, magnesium oxide particles, and alumina particles are preferable, inorganic particles such as silica particles, titanium oxide particles, and alumina particles are more preferable, and silica particles are even more preferable, as the inorganic particles.

One type of such inorganic particles may be independently used, or two or more types thereof may be used together.

Note that, in a case where the wettability and the dispersibility of the inorganic particles with respect to the solvent of the polyimide precursor solution are insufficient, as necessary, the surface of the inorganic particles may be modified.

Examples of a surface modification method of the inorganic particles include a method for treating the surface with alkoxy silane having an organic group represented by a silane coupling agent; and a method for coating the surface with an organic acid such as an oxalic acid, a citric acid, and a lactic acid.

An average particle diameter and the shape of the inorganic particles are not particularly limited, and may be suitably determined in accordance with each of the size and the shape of the aimed pore.

The content of the particles contained in the polyimide precursor solution used in the first step is preferably 0.1 mass % or more and 40 mass % or less, is more preferably 0.5 mass % or more and 30 mass % or less, is even more preferably 1 mass % or more and 25 mass % or less, is particularly preferably 1 mass % or more and 20 mass % or less, with respect to the total mass of the polyimide precursor solution.

(Solvent)

The polyimide precursor solution used in the first step contains the solvent.

It is preferable that the solvent is a solvent that dissolves the polyimide precursor, but does not dissolve or is difficult to dissolve the particles.

The solvent is not particularly limited insofar as having the properties described above, and a water-soluble organic solvent, water, and a mixed solvent thereof are preferable, and the mixed solvent of the water-soluble organic solvent and water (also referred to as an aqueous solvent) is more preferable, as the solvent.

-Water-Soluble Organic Solvent-

“Water-soluble” of the water-soluble organic solvent indicates that 1 mass % or more of a target substance is dissolved with respect to water at 25° C.

Examples of the water-soluble organic solvent include an aprotic polar solvent, a water-soluble ether-based solvent, a water-soluble ketone-based solvent, and a water-soluble alcohol-based solvent.

Specifically, examples of the aprotic polar solvent include at least one selected from the group consisting of N-methyl-2-pyrrolidone (NMP), N,N-dimethyl formamide (DMF), N,N-1,3-dimethyl-2-imidazolidinone (DMI), N,N-dimethyl acetamide (DMAc), N,N-diethyl acetamide (DEAc), dimethyl sulfoxide (DMSO), hexamethylene phosphoramide (HMPA), N-methyl caprolactam, N-acetyl-2-pyrrolidone, and 1,3-dimethyl-imidazolidine. Among them, N-methyl-2-pyrrolidone (NMP), N,N-dimethyl formamide (DMF), N,N-1,3-dimethyl-2-imidazolidinone (DMI), and N,N-dimethyl acetamide (DMAc) are preferable as the aprotic polar solvent.

The water-soluble ether-based solvent is a water-soluble solvent having an ether bond in one molecule. Examples of the water-soluble ether-based solvent include tetrahydrofuran (THF), dioxane, trioxane, 1,2-dimethoxyethane, diethylene glycol dimethyl ether, and diethylene glycol diethyl ether. Among them, tetrahydrofuran and dioxane are preferable as the water-soluble ether-based solvent.

The water-soluble ketone-based solvent is a water-soluble solvent having a ketone group in one molecule. Examples of the water-soluble ketone-based solvent include acetone, methyl ethyl ketone, and cyclohexanone. Among them, acetone is preferable as the water-soluble ketone-based solvent.

The water-soluble alcohol-based solvent is a water-soluble solvent having an alcoholic hydroxyl group in one molecule. Examples of the water-soluble alcohol-based solvent include methanol, ethanol, 1-propanol, 2-propanol, tert-butyl alcohol, ethylene glycol, monoalkyl ether of ethylene glycol, propylene glycol, monoalkyl ether of propylene glycol, diethylene glycol, monoalkyl ether of diethylene glycol, 1,2-propanediol, 1,3-propanediol, 1,3 -butanediol, 1,4-butanediol, 2,3 -butanedi ol, 1,5 -pentanediol, 2-butene-1,4-diol, 2-methyl-2,4-pentanediol, glycerin, 2-ethyl-2-hydroxymethyl-1,3 -propanediol, and 1,2,6-hexanetriol. Among them, methanol, ethanol, 2-propanol, ethylene glycol, monoalkyl ether of ethylene glycol, propylene glycol, monoalkyl ether of propylene glycol, diethylene glycol, and monoalkyl ether of diethylene glycol are preferable as the water-soluble alcohol-based solvent.

It is preferable that the water-soluble organic solvent contains an organic amine compound.

Hereinafter, the organic amine compound will be described.
Organic Amine Compound

The organic amine compound is a compound that amine-salifies the polyimide precursor (specifically, a carboxyl group of the polyimide precursor), and thus, increases solubility with respect to an aqueous solvent and also functions as an imidization promoter. Specifically, the organic amine compound is preferably an amine compound having a molecular weight of 170 or less. The organic amine compound is preferably a compound excluding a diamine compound that is a raw material of the polyimide precursor.

Note that, the organic amine compound is preferably a water-soluble compound. Water-soluble indicates that 1 mass % or more of a target substance is dissolved with respect to water at 25° C.

Examples of the organic amine compound include a primary amine compound, a secondary amine compound, and a tertiary amine compound.

Among them, the organic amine compound is preferably at least one type selected from the secondary amine compound and the tertiary amine compound (in particular, the tertiary amine compound). In a case where the tertiary amine compound or the secondary amine compound (in particular, the tertiary amine compound) is applied as the organic amine compound, the solubility of the polyimide precursor with respect to the solvent easily increases, film forming properties are easily improved, and preservation stability of the polyimide precursor solution is easily improved.

In addition, examples of the organic amine compound also include a di- or higher polyvalent amine compound in addition to a monovalent amine compound. In a case where the di- or higher polyvalent amine compound is applied, a pseudo-crosslinked structure is easily formed between the molecules of the polyimide precursor, and the preservation stability of the polyimide precursor solution is easily improved.

Examples of the primary amine compound include methyl amine, ethyl amine, n-propyl amine, isopropyl amine, 2-ethanol amine, and 2-amino-2-methyl-1-propanol.

Examples of the secondary amine compound include dimethyl amine, 2-(methyl amino)ethanol, 2-(ethyl amino)ethanol, and morpholine.

Examples of the tertiary amine compound include 2-dimethyl aminoethanol, 2-diethyl aminoethanol, 2-dimethyl aminopropanol, pyridine, triethyl amine, picoline, N-methyl morpholine, N-ethyl morpholine, 1,2-dimethyl imidazole, 2-ethyl-4-methyl imidazole, and N-alkyl piperidine (for example, N-methyl piperidine, N-ethyl piperidine, and the like).

It is preferable that the organic amine compound is the tertiary amine compound from the viewpoint of obtaining a film having a high strength. From such a viewpoint, it is more preferable that the organic amine compound is at least one type selected from the group consisting of 2-dimethyl aminoethanol, 2-diethyl aminoethanol, 2-dimethyl aminopropanol, pyridine, triethyl amine, picoline, N-methyl morpholine, N-ethyl morpholine, 1,2-dimethyl imidazole, 2-ethyl-4-methyl imidazole, N-methyl piperidine, and N-ethyl piperidine. In particular, N-alkyl morpholine is preferably used as the organic amine compound.

Here, an amine compound of an aliphatic cyclic structure or an aromatic cyclic structure having a heterocyclic structure containing nitrogen (hereinafter, referred to as a “nitrogen-containing heterocyclic amine compound”) is also preferable as the organic amine compound, from the viewpoint of obtaining a film having a high strength. It is more preferable that the nitrogen-containing heterocyclic amine compound is the tertiary amine compound. That is, it is more preferable that the nitrogen-containing heterocyclic amine compound is a tertiary cyclic amine compound.

Examples of the tertiary cyclic amine compound include isoquinolines (that is, an amine compound having an isoquinoline skeleton), pyridines (that is, an amine compound having a pyridine skeleton), pyrimidines (that is, an amine compound having a pyrimidine skeleton), pyrazines (that is, an amine compound having a pyrazine skeleton), piperazines (that is, an amine compound having a piperazine skeleton), triazines (that is, an amine compound having a triazine skeleton), imidazoles (that is, an amine compound having an imidazole skeleton), morpholines (that is, an amine compound having a morpholine skeleton), polyaniline, and polypyridine.

From the viewpoint of obtaining a polyimide film in which a variation in a film thickness is suppressed, at least one type selected from the group consisting of morpholines, pyridines, piperidines, and imidazoles is preferable, and morpholines (that is, the amine compound having a morpholine skeleton), that is, a morpholine-based compound, are more preferable, as the tertiary cyclic amine compound. Among them, at least one type selected from the group consisting of N-methyl morpholine, N-methyl piperidine, pyridine, 1,2-dimethyl imidazole, 2-ethyl-4-methyl imidazole, and picoline is more preferable, and N-methyl morpholine is even more preferable.

One type of such organic amine compounds may be independently used, or two or more types thereof may be used together.

A content ratio of the organic amine compound used in the present exemplary embodiment is preferably 30% or less, is more preferably 15% or less, with respect to the total mass of the polyimide precursor solution. In addition, a lower limit value of the content ratio of the organic amine compound is not particularly limited, and is, for example, 1% or more with respect to the total mass of the polyimide precursor solution.

One type of such water-soluble organic solvents may be independently used, or two or more types thereof may be used together.

Note that, a boiling point of the water-soluble organic solvent is preferably 270° C. or lower, is more preferably 60° C. or higher and 250° C. or lower, and is even more preferably 80° C. or higher and 230° C. or lower, from the viewpoint of preventing the water-soluble organic solvent from remaining in the polyimide porous film and from the viewpoint of obtaining a polyimide porous film having a high mechanical strength.

A content ratio of the water-soluble organic solvent used in the present exemplary embodiment is preferably 30 mass % or less, and is more preferably 20 mass % or less, with respect to the total mass of the aqueous solvent contained in the polyimide precursor solution.

In addition, a lower limit value of the content ratio of the water-soluble organic solvent is not particularly limited, and is, for example, 1% or more with respect to the total mass of the polyimide precursor solution.

-Water-

Examples of water include distilled water, ion exchange water, ultrafiltered water, and pure water.

A content ratio of water used in the present exemplary embodiment is preferably 50 mass % or more and 90 mass % or less, is more preferably 60 mass % or more and 90 mass % or less, and is even more preferably 60 mass % or more and 80 mass % or less, with respect to the total mass of the aqueous solvent contained in the polyimide precursor solution.

The content of the aqueous solvent contained in the polyimide precursor solution used in the first step is preferably 50 mass % or more and 99 mass % or less, and is more preferably 40 mass % or more and 99 mass % or less, with respect to the total mass of the polyimide precursor solution.

(Other Additives)

The polyimide precursor solution used in the first step may contain a catalyst for promoting an imidization reaction, a leveling material for improving film formation quality, and the like.

A dehydrating agent such as an acid anhydride, an acid catalyst such as a phenol derivative, a sulfonic acid derivative, and a benzoic acid derivative, and the like may be used as the catalyst for promoting the imidization reaction.

In addition, the polyimide precursor solution may contain, for example, a conductive agent (for example, a substance having a volume resistivity of less than 10⁷ Ω·cm as conductivity) or a semiconductive agent (for example, a substance having a volume resistivity of 10⁷ Ω·cm or more and 10¹³ Ω·cm or less as conductivity), in order to apply conductivity, in accordance with the intended use of the polyimide film.

Examples of the conductive agent include carbon black (for example, acidic carbon black having pH of 5.0 or lower); a metal (for example, aluminum, nickel, and the like); a metal oxide (for example, yttrium oxide, tin oxide, and the like); and an ion conductive substance (for example, potassium titanate, LiCl, and the like).

One type of such conductive agents may be independently used, or two or more types thereof may be used together.

In addition, the polyimide precursor solution may contain inorganic particles that are added in order to improve a mechanical strength, in accordance with the intended use of the polyimide film.

Examples of the inorganic particles include a particulate material such as a silica powder, an alumina powder, a barium sulfate powder, a titanium oxide powder, mica, and talc.

In addition, the polyimide precursor solution may contain LiCoO₂, LiMn₂O, and the like that are used as an electrode of a lithium ion battery.

[Preparation Method of Polyimide Precursor Solution]

A preparation method of the polyimide precursor solution used in the first step is not particularly limited.

A method for preparing the polyimide precursor solution by synthesizing the polyimide precursor in the dispersion liquid in which the particles are dispersed in the aqueous solvent is preferable from the viewpoint of simplifying steps. Note that, in a case where the particles are the resin particles, the dispersion liquid described above may be obtained by granulating the resin particles in the aqueous solvent.

Specifically, examples of the preparation method of the polyimide precursor solution include the following methods.

First, the resin particles are granulated in the aqueous solvent, and thus, the resin particle dispersion liquid is obtained. Subsequently, in the resin particle dispersion liquid, a resin (specifically, the polyimide precursor) is generated by polymerizing a tetracarboxylic dianhydride and a diamine compound in the presence of an organic amine compound, and thus, the polyimide precursor solution is obtained.

Another example of the preparation method of the polyimide precursor solution includes a method for mixing a solution in which the polyimide precursor is dissolved in the aqueous solvent and the resin particles in a dry state, and a method for mixing the solution in which the polyimide precursor is dissolved in the aqueous solvent and a dispersion liquid in which the resin particles are dispersed in advance in the aqueous solvent.

[Applying and Drying of Polyimide Precursor Solution]

In the first step, the polyimide precursor solution obtained by the method described above is applied onto a substrate, and thus, a coated film is formed. The coated film contains the solution containing the polyimide precursor, and the particles. Then, the particles in the coated film are distributed in a state where aggregation is suppressed.

After that, the coated film formed on the substrate is dried, and thus, a film containing the polyimide precursor and the particles is formed.

The substrate onto which the polyimide precursor solution is applied is not particularly limited.

Examples of the substrate include a resin substrate of polystyrene, polyethylene terephthalate, or the like; a glass substrate; a ceramic substrate; a metal substrate of iron, stainless steel (SUS), or the like; and a composite material substrate in which such materials are combined.

In addition, as necessary, for example, a peeling layer may be provided on the substrate by performing a peeling treatment with a silicone-based peeling agent, a fluorine-based peeling agent, or the like. In addition, it is also effective that the surface of a base material is roughened to a size of approximately the particle diameter of the particles, and the exposure of the particles on a contact surface of the base material is promoted.

A method for applying the polyimide precursor solution onto the substrate is not particularly limited, and examples thereof include various methods such as a spray coating method, a rotation coating method, a roll coating method, a bar coating method, a slit die coating method, and an ink jet coating method.

A method for drying the coated film formed on the substrate is not particularly limited, and examples thereof include various methods such as heating drying, natural drying, and vacuum drying.

More specifically, it is preferable that the film is formed by drying the coated film such that the solvent remaining in the film is 50% or less (preferably 30% or less) with respect to a solid content of the film.

Note that, a dispersion state of the particles is changed by a drying rate, and thus, the irregularity of a dispersion state of the pores in the polyimide porous film to be manufactured is controlled by the drying rate.

Specifically, in a case where the drying rate is slow, the particles are easily moved in the coated film, and thus, the dispersibility of the particles in the coated film increases, and the irregularity of the dispersion state of the pores in the polyimide porous film tends to be low. On the other hand, in a case where the drying rate is fast, the particles are easily immobilized in a state of being unevenly distributed in the coated film, and thus, the irregularity of the dispersion state of the pores in the polyimide porous film tends to be high.

The drying rate may be controlled by adjusting a drying temperature or adjusting a drying time.

In the first step, in a process where the coated film is obtained, and then, is dried to form the film, a treatment for exposing the particles may be performed. By performing the treatment for exposing the particles, an opening rate of the polyimide porous film may be increased.

Specifically, examples of the treatment for exposing the particles include the following method.

In the process where the coated film containing the polyimide precursor and the particles is obtained, and then, the coated film is dried to form the film containing the polyimide precursor and the particles, the polyimide precursor in the formed film is in a state of being dissoluble in water, as described above. For this reason, the film is subjected to, for example, a treatment for wiping out the film with water, a treatment for dipping the film in water, or the like, and thus, the particles may be exposed from the film. Specifically, for example, a treatment for exposing the particles by wiping out the surface of the film with water is performed, and thus, the polyimide precursor (and the solvent) covering the particles is removed. As a result thereof, the particles are exposed on the treated surface of the film.

In particular, in a case where a film is formed in which particles are embedded, it is preferable that the treatments described above are adopted as a treatment for exposing the particles embedded in the film.

[Second Step and Third Step]

In the second step, the particles are removed from the film obtained in the first step. The particles are removed from the film, and thus, a porous film is formed.

In addition, in the third step, the film is heated, and the polyimide precursor in the film is imidized.

The polyimide porous film is manufactured through the second step and the third step.

[Removal of Particles]

In the second step, a method for removing the particles from the film may be suitably determined in accordance with the particles in the film.

Examples of the method for removing the particles from the film include a method for decomposing and removing the particles (preferably the resin particles) by heating, a method for dissolving and removing the particles with an organic solvent, and a method for decomposing and removing the resin particles with laser or the like.

Only one type of such methods may be performed, or two or more types thereof may be used together. A removal rate of the particles is adjusted by using two or more types of the methods for removing the particles from the film together, and thus, the shape of the pore (specifically, the flatness) may be controlled.

In the case of using the method for decomposing and removing the particles by heating, there is a method that also functions as the third step described below, but it is preferable that the particles are removed from the film by the second step, and then, the third step (specifically, the imidization) is performed, from the viewpoint of easily controlling the shape of the pore (specifically, the flatness).

In the second step, in the case of the method for decomposing and removing the particles by heating, examples of a heating condition include the following conditions.

A heating temperature is preferably 150° C. or higher and 350° C. or lower, is more preferably 170° C. or higher and 350° C. or lower, and is even more preferably 200° C. or higher and 350° C. or lower, for example.

In addition, a heating time is preferably 1 minute or longer and 60 minutes or shorter, is more preferably 1 minute or longer and 45 minutes or shorter, and is even more preferably 1 minute or longer and 30 minutes or shorter, for example.

In the case of using the method for dissolving and removing the resin particles with the organic solvent, specifically, examples thereof include a method in which the film is brought into contact with the organic solvent, and the resin particles are dissolved in the organic solvent and are removed.

Examples of the method for bringing the film into contact with the organic solvent include a method for dipping the film in the organic solvent, a method for applying the organic solvent onto the film, and a method for bringing the film into contact with organic solvent vapor.

The organic solvent used to dissolve the resin particles is not particularly limited insofar as being an organic solvent that does not dissolve the polyimide precursor and polyimide but is capable of dissolving the resin particles.

In a case where the particles are the resin particles, for example, ethers such as tetrahydrofuran and 1,4-dioxane; aromatics such as benzene and toluene; ketones such as acetone; and esters such as ethyl acetate; are used as the organic solvent.

Among them, ethers such as tetrahydrofuran and 1,4-dioxane; or aromatics such as benzene and toluene are preferable, and tetrahydrofuran or toluene is more preferably used.

In the case of using the method for dissolving and removing the particles with the organic solvent, it is preferable that the method is performed when an imidization rate of the polyimide precursor in the film is 10% or more, from the viewpoint of removal properties of the particles and of preventing the film itself from being dissolved in the organic solvent.

Examples of a method for setting the imidization rate to 10% or more include heating under a heating condition of a first stage described below.

That is, it is preferable that the heating of the first stage described below is performed, and then, the particles in the film are dissolved in the organic solvent and are removed.

[Imidization]

In the third step, for example, multi-stage heating of two or more stages is preferably used as the heating for imidizing the polyimide precursor in the film.

For example, in a case where the particles are the resin particles, and are heated in two stages, specifically, the following heating conditions are adopted.

Note that, the shape of the pore (specifically, the flatness) is controlled by the heating condition at the time of imidizing the polyimide precursor. The heating condition (that is, the heating temperature and the heating time) is suitably controlled, and thus, a contraction rate of the film (in particular, the thickness direction) is changed, and therefore, the shape of the pore (specifically, the flatness) is controlled.

It is desirable that a heating condition of a first stage is a temperature at which the shape of the resin particles is retained. Specifically, for example, the temperature is preferably in a range of 50° C. or higher and lower than 250° C., and is more preferably in a range of 100° C. or higher and 230° C. or lower. In addition, the heating time is preferably a range of 10 minutes or longer and 120 minutes or shorter. The heating time may be shortened as the heating temperature is high.

Note that, in the heating condition of the first stage described above, the heating temperature indicates a preimidization temperature, and the heating time indicates a preimidization time.

Examples of a heating condition of a second stage include heating in a condition of 250° C. or higher and 500° C. or lower (preferably 300° C. or higher and 450° C. or lower) and 20 minutes or longer and 120 minutes or shorter. According to the heating condition in this range, the imidization reaction further progresses. In a heating reaction, the heating is preferably performed by increasing the temperature in a stepwise manner or gradually at a constant rate until the temperature reaches the final temperature of the heating.

Note that, in the heating condition of the second stage described above, the heating temperature indicates a burning temperature, and the heating time indicates a burning time.

Note that, the heating condition is not limited to the method for performing heating in two stages described above, and for example, a method for performing heating in one stage may be adopted. In the case of the method for performing heating in one stage, for example, the imidization may be completed only by the heating condition described in the second stage described above.

Here, the imidization rate of the polyimide precursor will be described.

Examples of the polyimide precursor of which a part is imidized include a precursor of a structure having a repeating unit represented by the following general formula (I-1), the following general formula (I-2), and the following general formula (I-3).

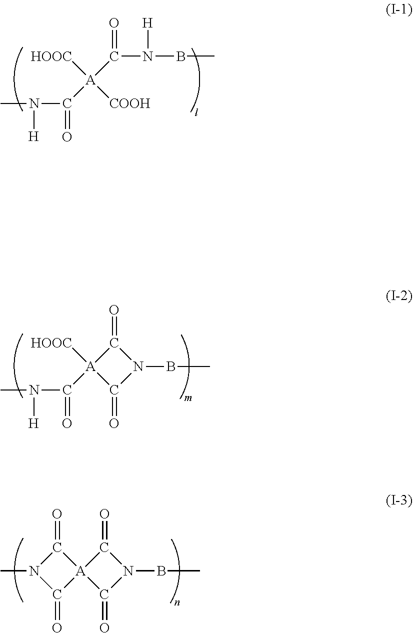

In the general formula (I-1), the general formula (I-2), and the general formula (I-3), A represents a tetravalent organic group, and B represents a divalent organic group. 1 represents an integer of 1 or more, and m and n each independently represent an integer of 0 or 1 or more.

Note that, A and B are identical to A and B in the general formula (I) described above.

The imidization rate of the polyimide precursor indicates a ratio of the number of imidization ring-closing bonding parts (2n+m) to the total number of bonding parts (2I+2m+2n) in bonding parts of the polyimide precursor (that is, a reaction part between a tetracarboxylic dianhydride and a diamine compound). That is, the imidization rate of the polyimide precursor is represented by “(2n+m)/(2I+2m+2n)”.

Note that, the imidization rate of the polyimide precursor (that is, the value of “(2n+m)/(2I+2m+2n)”) is measured by the following method.

-Measurement of Imidization Rate of Polyimide Precursor-

Preparation of Polyimide Precursor Sample

(i) The polyimide precursor solution that is a measurement target is applied onto a silicon wafer to have a film thickness in a range of 1 μm or more and 10 μm or less, and thus, a coated film sample is prepared.

(ii) The coated film sample is dipped in tetrahydrofuran (THF) for 20 minutes, and the solvent in the coated film sample is substituted with tetrahydrofuran (THF). A dipping solvent is not limited to THF, and is selected from solvents that do not dissolve the polyimide precursor but are capable of being mixed with a solvent component contained in the polyimide precursor solution. Specifically, an alcohol solvent such as methanol and ethanol, and an ether compound such as dioxane are used.

(iii) The coated film sample is taken out from THF, N2 gas is blown to THF attached to the surface of the coated film sample to remove THF. The coated film sample is dried by being treated at a temperature in a range of 5° C. or higher and 25° C. or lower for 12 hours or longer, under reduced pressure of 10 mmHg or less, and thus, a polyimide precursor sample is prepared.
Preparation of 100% Imidized Reference Sample

(iv) As with (i) described above, the polyimide precursor solution that is the measurement target is applied onto a silicon wafer, and thus, a coated film sample is prepared.

(v) The coated film sample is heated at 380° C. for 60 minutes to perform the imidization reaction, and thus, a 100% imidized reference sample is prepared.
Measurement and Analysis

(vi) An infrared light absorption spectrum of the 100% imidized reference sample and the polyimide precursor sample is measured by using a Fourier transform infrared spectrophotometer (FT-730, manufactured by HORIBA, Ltd.). A ratio I′(100) of a light absorption peak (Ab′ (1780 cm⁻¹)) derived from an imide bond in the vicinity of 1780 cm⁻¹ to a light absorption peak (Ab′ (1500 cm⁻¹)) derived from an aromatic ring in the vicinity of 1500 cm⁻¹, of the 100% imidized reference sample is obtained.

(vii) Similarly, the polyimide precursor sample is measured, and thus, a ratio I(x) of a light absorption peak (Ab (1780 cm⁻¹)) derived from an imide bond in the vicinity of 1780 cm⁻¹ to a light absorption peak (Ab (1500 cm⁻¹)) derived from an aromatic ring in the vicinity of 1500 cm⁻¹ is obtained.

Then, the imidization rate of the polyimide precursor is calculated on the basis of the following expressions, by using each of the measured light absorption peaks I′(100) and I(x).
Expression: Imidization Rate of Polyimide Precursor=I(x)/I′(100)
Expression: I′(100)=(Ab′ (1780 cm⁻¹))/(Ab′ (1500 cm⁻¹))
Expression: I(x)=(Ab (1780 cm⁻¹))/(Ab (1500 cm⁻¹))

Note that, the measurement of the imidization rate of the polyimide precursor is applied to the measurement of an imidization rate of an aromatic polyimide precursor. In a case where the imidization rate of the aliphatic polyimide precursor is measured, a peak derived from a structure that is not changed before and after the imidization reaction is used as internal reference peak, instead of the absorption peak of the aromatic ring.

The substrate used in the first step may be peeled off from the film after the first step, may be peeled off from the film after the second step, or may be peeled off from the obtained polyimide porous film after the third step.

The polyimide porous film may have a single-layer structure, or may have a multi-layer structure.

[Application of Adhesive Resin Particles with respect to Surface of Polyimide Porous Film]

In order to apply the adhesive resin particles onto the surface of the polyimide porous film, the following method may be used.

Examples of an applying method of the adhesive resin particles include a spray method, a bar coating method, a die coating method, a knife coating method, a roll coating method, a reverse roll coating method, a gravure coating method, a screen printing method, an ink jet method, a laminating method, and an electrophotographic method. Note that, the adhesive resin particles may be dispersed in a dispersion medium to prepare a liquid composition, the liquid composition may be applied onto the surface of the polyimide porous film, and the dispersion medium may be removed.

An attachment amount of the adhesive resin particles with respect to the surface of the polyimide porous film may be controlled by an applied amount of the adhesive resin particles in the applying method described above, or the applied amount of the adhesive resin particles applied onto the surface of the polyimide porous film may be adjusted by using an applicator or the like.

In the separator according to the present exemplary embodiment, it is preferable that the adhesive resin particles are attached onto two surfaces of the polyimide porous film, and the separator also includes an aspect in which the adhesive resin particles are attached onto only one surface of the polyimide porous film.

<Secondary Battery and Manufacturing Method of Secondary Battery>

A secondary battery according to the present exemplary embodiment and the manufacturing method of a secondary battery according to the present exemplary embodiment will be described.

The secondary battery according to the present exemplary embodiment, includes: the electrode described above; and the separator according to the present exemplary embodiment, described above, in which an adhesive layer of the adhesive resin particles is provided between the electrode and the polyimide porous film.

That is, the secondary battery according to the present exemplary embodiment, includes: the electrode; the polyimide porous film (that is, the polyimide porous film provided in the separator according to the present exemplary embodiment); and the adhesive layer of the adhesive resin particles provided on the interface between the electrode and the polyimide porous film.

The manufacturing method of a secondary battery according to the present exemplary embodiment, includes: a step of allowing the separator for a non-aqueous secondary battery according to the present exemplary embodiment, described above, to adhere to an electrode by at least one of pressure and heat (hereinafter, also referred to as an adhering step).

Hereinafter, the secondary battery according to the present exemplary embodiment and the manufacturing method of a secondary battery according to the present exemplary embodiment will be described with reference to the figure, by using a lithium ion secondary battery as an example.

The figure is a partial sectional schematic view illustrating an example of the secondary battery (specifically, the lithium ion secondary battery) according to the present exemplary embodiment.

As illustrated in the figure, a lithium ion secondary battery 100 includes a cathode active material layer 110, an adhesive layer 410, a separator layer 510, an adhesive layer 420, and an anode active material layer 310, which are contained inside an exterior member (not illustrated). The cathode active material layer 110 is provided on a cathode collector 130, and the anode active material layer 310 is provided on an anode collector 330. The separator layer 510 is provided such that the cathode active material layer 110 and the anode active material layer 310 are separated from each other, and is disposed between the cathode active material layer 110 and the anode active material layer 310 such that the cathode active material layer 110 and the anode active material layer 310 face each other. The separator layer 510 includes a separator 511 and an electrolytic solution 513 filled inside the pore of the separator 511. Here, the separator according to the present exemplary embodiment (specifically, the polyimide porous film), described above, is applied to the separator 511, and the adhesive layers 410 and 420 indicate the adhesive layer of the adhesive resin particles. More specifically, the adhesive layer 410 is formed on the interface between a non-opening portion of the separator 511 and the cathode active material layer 110, and the adhesive layer 420 is formed on the interface between a non-opening portion of the separator 511 and the anode active material layer 310.

Note that, the cathode collector 130 and the anode collector 330 are a member that is provided as necessary.

(Cathode Collector 130 and Anode Collector 330) A material used in the cathode collector 130 and the anode collector 330 is not particularly limited, and may be a known conductive material. For example, a metal such as aluminum, copper, nickel, and titanium may be used.

(Cathode Active Material Layer 110)

The cathode active material layer 110 is a layer containing a cathode active material. As necessary, a known additive such as a conductive auxiliary agent and a binding resin may be contained. The cathode active material is not particularly limited, and a known cathode active material may be used. Examples of the cathode active material include a composite oxide containing lithium (for example, LiCoO₂, LiNiO₂, LiMnO₂, LiMn₂O₄, LiFeMnO₄, and LiV₂O₅), a phosphate containing lithium (for example, LiFePO₄, LiCoPO₄, LiMnPO₄, and LiNiPO₄), and a conductive polymer (for example, polyacetylene, polyaniline, polypyrrole, and polythiophene). One type of such cathode active materials may be independently used, or two or more types thereof may be used together.

(Anode Active Material Layer 310)

The anode active material layer 310 is a layer containing an anode active material. As necessary, a known additive such as a binding resin may be contained. The anode active material is not particularly limited, and a known anode active material may be used. Examples of the anode active material include a carbon material (for example, graphite (for example, natural graphite and artificial graphite), a carbon nanotube, graphitized carbon, and low-temperature burned carbon), a metal (for example, aluminum, silicon, zirconium, and titanium), and a metal oxide (for example, tin dioxide, and lithium titanate). One type of such anode active materials may be independently used, or two or more types thereof may be used together.

(Electrolytic Solution 513)

Examples of the electrolytic solution 513 are capable of including a non-aqueous electrolyte solution containing an electrolyte and a non-aqueous solvent.

Examples of the electrolyte include an electrolyte of a lithium salt (for example, LiPF₆, LiBF₄, LiSbF₆, LiAsF₆, LiClO₄, LiN(FSO₂)₂, LiN(CF₃SO₂)₂, LiN(C₂F₅SO₂), and LiC(CF₃SO₂)₃). One type of such electrolytes may be independently used, or two or more types thereof may be used together.

Examples of the non-aqueous solvent include cyclic carbonate (for example, ethylene carbonate, propylene carbonate, and butylene carbonate), and chain carbonate (for example, diethyl carbonate, dimethyl carbonate, ethyl methyl carbonate, methyl acetate, ethyl acetate, methyl propionate, ethyl propionate, y-butyrolactone, 1,2-dimethoxyethane, and 1,2-diethoxyethane). One type of such non-aqueous solvents may be independently used, or two or more types thereof may be used together.

(Manufacturing Method of Lithium Ion Secondary Battery 100)

An example of a method for manufacturing the lithium ion secondary battery 100 will be described.

A coating liquid for forming the cathode active material layer 110 containing the cathode active material is applied onto the cathode collector 130 and is dried, and thus, a cathode including the cathode active material layer 110 provided on the cathode collector 130 is obtained.

Similarly, a coating liquid for forming the anode active material layer 310 containing the anode active material is applied onto the anode collector 330 and is dried, and thus, an anode including the anode active material layer 310 provided on the anode collector 330. The cathode and the anode may be respectively subjected to compression processing, as necessary.

Next, the separator 511 is disposed between the cathode active material layer 110 and the anode active material layer 310 of the anode such that the cathode active material layer 110 of the cathode and the anode active material layer 310 of the anode face each other, and thus, a laminated structure is obtained. In the laminated structure, the cathode which includes the cathode collector 130 and the cathode active material layer 110, the separator layer 510, and the anode which includes the anode active material layer 310 and the anode collector 330 are laminated in this order. Then, at least one of pressure and heat is applied to the laminated structure, and thus, the adhesion between the cathode and the separator 511 and the adhesion between the separator 511 and the anode are performed (the adhering step). Note that, the laminated structure may be subjected to compression processing, as necessary.

Next, the laminated structure is contained in the exterior member, and then, the electrolytic solution 513 is injected into the laminated structure. The injected electrolytic solution 513 is also infiltrated into the pore of the separator 511.

As described above, the lithium ion secondary battery 100 is obtained. In the adhering step described above, heat and pressure used in the adhesion between the cathode and the separator 511 and the adhesion between the separator 511 and the anode may be determined in accordance with the type of adhesive resin particles contained in the separator 511. In addition, in the adhering step described above, an applying condition of heat and pressure used in the adhesion may be determined in accordance with the type of adhesive resin particles contained in the separator 511.

Hereinafter, an adhering step in a case where the adhesive resin particles are the pressure-responsive particles will be described.

Pressure is applied to the laminated structure including the separator 511 in which the pressure-responsive particles are attached to the surface in the thickness direction, and thus, the adhesion between the cathode and the separator 511 and the adhesion between the separator 511 and the anode are performed.

In a case where pressure is applied to the laminated structure in the thickness direction, the pressure-responsive particles are fluidized by pressure and exhibit adhesiveness, and thus, the adhesion between the cathode and the separator 511 and the adhesion between the separator 511 and the anode are performed.

A known pressure device may be used as a means for applying pressure to the laminated structure. Examples of a pair of pressurize members provided in the pressure device include a combination of a pressure roll and a pressure roll, a combination of a pressure roll and a pressure belt, and a combination of a pressure belt and a pressure belt.

Note that, the pressure to be applied to the laminated structure depends on the type of pressure-responsive particles, and is preferably 3 MPa or more and 300 MPa or less, is more preferably 10 MPa or more and 200 MPa or less, and is even more preferably 30 MPa or more and 150 MPa or less, for example.

Note that, when pressure is applied to the laminated structure, heat may be applied to the laminated structure.

As described above, the lithium ion secondary battery according to the present exemplary embodiment has been described with reference to the figure, but the lithium ion secondary battery according to the present exemplary embodiment is not limited thereto. The form of the lithium ion secondary battery is not particularly limited insofar as the separator according to the present exemplary embodiment is applied.

### EXAMPLES

Hereinafter, the exemplary embodiment of the invention will be described in detail by examples, but the exemplary embodiment of the invention is not limited to such examples. In the following description, unless otherwise noted, “parts” and “%” are based on a mass.

<<Preparation of Pressure-Responsive Particles>>

As described below, pressure-responsive particles are prepared.

<Preparation of Dispersion Liquid Containing Styrene-Based Resin Particles>

[Preparation of Styrene-Based Resin Particle Dispersion Liquid (St1)]
Styrene: 390 parts
n-Butyl Acrylate: 100 parts
Acrylic Acid: 10 parts
Dodecanethiol: 7.5 parts

The materials described above are mixed and dissolved, and thus, a monomer solution is prepared.

8 parts of an anionic surfactant (Dowfax2A1, manufactured by The Dow Chemical Company) is dissolved in 205 parts of ion exchange water, the monomer solution is added thereto, and dispersion and emulsification are performed, and thus, an emulsified liquid is obtained.

2.2 parts of an anionic surfactant (Dowfax2A1, manufactured by The Dow Chemical Company) is dissolved in 462 parts of ion exchange water, is put in a polymerization flask provided with a stirrer, a thermometer, a reflux cooling pipe, and a nitrogen gas introduction pipe, is heated to 73° C. while being stirred, and is retained.

3 parts of ammonium persulfate is dissolved in 21 parts of ion exchange water, and is dropped into the polymerization flask for 15 minutes through a metering pump, and then, the emulsified liquid is dropped for 160 minutes through the metering pump.

Next, the polymerization flask is retained at 75° C. for 3 hours while being slowly stirred, and then, the temperature returns to a room temperature.

Accordingly, a styrene-based resin particle dispersion liquid (St1) containing styrene-based resin particles, in which a volume average particle diameter (D50v) of resin particles is 174 nm, a weight average molecular weight according to GPC (UV detection) is 49000, a glass transition temperature is 54° C., and a solid content is 42%, is obtained.

The styrene-based resin particles are extracted by drying the styrene-based resin particle dispersion liquid (St1), thermal behavior in a temperature range of −100° C. to 100° C. is analyzed with a differential scanning calorimeter (DSC-60A, manufactured by SHIMADZU CORPORATION), and one glass transition temperature is observed. The glass transition temperature is shown in Table 1.

[Preparation of Styrene-Based Resin Particle Dispersion Liquids (St2) and (St3)]

Styrene-based resin particle dispersion liquids (St2) and (St3) are prepared as with the preparation of the styrene-based resin particle dispersion liquid (St1), except that a monomer is changed as shown in Table 1.

In Table 1, monomers are described by the following abbreviations.

Styrene: St, n-Butyl Acrylate: BA, 2-Ethyl Hexyl Acrylate: 2EHA, Acrylic Acid: AA

TABLE 1
Styrene-based resin particle dispersion liquid

| | Polymerization component | | | | D50v of | | |
|---|---|---|---|---|---|---|---|
| | (mass ratio) | | | | resin particles | Mw | Tg |
| Number | St | BA | 2EHA | AA | nm | — | ° C. |
| St1 | 78 | 20 | 0 | 2 | 174 | 49000 | 54 |
| St2 | 88 | 10 | 0 | 2 | 170 | 50000 | 76 |
| St3 | 78 | 0 | 20 | 2 | 167 | 49000 | 56 |

<Preparation of Dispersion Liquid Containing Composite Resin Particles>

[Preparation of Composite Resin Particle Dispersion Liquid (M1)]
Styrene-Based Resin Particle Dispersion Liquid (St1): 1190 parts (a solid content of 500 parts)
2-Ethyl Hexyl Acrylate: 250 parts
n-Butyl Acrylate: 250 parts
Ion Exchange Water: 982 parts

The materials described above are put in a polymerization flask, are stirred at 25° C. for 1 hour, and then, are heated to 70° C.

2.5 parts of ammonium persulfate is dissolved in 75 parts of ion exchange water, and is dropped into the polymerization flask for 60 minutes through a metering pump.

Next, the polymerization flask is retained at 70° C. for 3 hours while being slowly stirred, and then, the temperature returns to a room temperature.

Accordingly, a composite resin particle dispersion liquid (M1) containing composite resin particles, in which a volume average particle diameter (D50v) of resin particles is 219 nm, a weight average molecular weight according to GPC (UV detection) is 219000, and a solid content is 32%, is obtained.

The composite resin particles are extracted by drying the composite resin particle dispersion liquid (M1), thermal behavior in a temperature range of −150° C. to 100° C. is analyzed with a differential scanning calorimeter (DSC-60A, manufactured by SHIMADZU CORPORATION), and two glass transition temperatures Tg are observed. The glass transition temperatures are shown in Table 2.

[Preparation of Composite Resin Particle Dispersion Liquids (M2) to (M4)]

Composite resin particle dispersion liquids (M2) to (M4) are prepared as with the preparation of the composite resin particle dispersion liquid (M1), except that the styrene-based resin particle dispersion liquid (St1) is changed as shown in Table 2 or a polymerization component of a (meth)acrylic ester-based resin is changed as shown in Table 2.

TABLE 2
Composite resin particle dispersion liquid

| | St-based resin | | | | Composite resin particles | | | | |
|---|---|---|---|---|---|---|---|---|---|
| | St-based resin | | | Ac-based resin | Mass ratio of St-based | D50v of resin | | | |
| | particle dispersion | Polymerization | Tg | Polymerization | resin to Ac-based resin | particles | Mw | Tg | |
| Number | liquid | component | ° C. | component | (St:Ac) | nm | — | ° C. | ° C. |
| M1 | St1 | St/BA/AA = 78/20/2 | 54 | 2EHA/BA = 50/50 | 50:50 | 219 | 219000 | −52 | 54 |
| M2 | St2 | St/BA/AA = 88/10/2 | 76 | 2EHA/BA = 50/50 | 50:50 | 218 | 240000 | −52 | 76 |
| M3 | St3 | St/2EHA/AA = 78/20/2 | 56 | 2EHA/BA = 50/50 | 50:50 | 227 | 237000 | −52 | 56 |
| M4 | St1 | St/BA/AA = 78/20/2 | 54 | 2EHA/BA = 70/30 | 50:50 | 226 | 260000 | −52 | 54 |

<Preparation of Pressure-Responsive Particles>

[Preparation of Pressure-Responsive Particles (1)]
Composite Resin Particle Dispersion Liquid (M1): 504 parts
Ion Exchange Water: 710 parts
Anionic Surfactant (Dowfax2A1, manufactured by The Dow Chemical Company): 1 part

The materials described above are put in a reaction vessel provided with a thermometer and a pH meter, an aqueous solution of a nitric acid of 1.0% is added thereto at a temperature of 25° C. such that pH is adjusted to 3.0, and then, 23 parts of an aqueous solution of aluminum sulfate of 2.0% is added thereto while being dispersed with a homogenizer (ULTRA-TURRAX T50, manufactured by IKA-Werke GmbH & CO. KG) at the number of rotations of 5000 rpm. Next, a stirrer and a mantle heater are provided in the reaction vessel, the temperature is increased at a temperature increase rate of 0.2° C./minute up to a temperature of 40° C., and at a temperature increase rate of 0.05° C./minute after exceeding 40° C., and a particle diameter is measured with a Multisizer II (an aperture diameter of 50 μm, manufactured by Beckman Coulter, Inc.) every 10 minutes. The temperature is retained when a volume average particle diameter is 5.0 μm, and 170 parts of the styrene-based resin particle dispersion liquid (St1) is put therein for 5 minutes. After the input is ended, retention is performed at 50° C. for 30 minutes, and then, an aqueous solution of sodium hydroxide of 1.0% is added thereto such that the pH of slurry is adjusted to 6.0. Next, the temperature is increased to 90° C. at a temperature increase rate of 1° C./minute while the pH is adjusted to 6.0 every 5° C., and is retained at 90° C. The shape of the particles and surface properties are observed with an optical microscope and a field-emission scanning electron microscope (FE-SEM), and the coalescence of the particles is checked in 10 hours, and thus, the vessel is cooled with cooling water to 30° C. for 5 minutes.

The slurry after the cooling passes through a Nylon mesh having an opening of 15 μm such that coarse particles are removed, and the slurry passing through the mesh is subjected to suction filtration with an aspirator. A solid content remaining on filter paper is crushed with hands as fine as possible, is put in ion exchange water having a temperature of 30° C. that is 10 times the solid content, and is stirred for 30 minutes. Next, suction filtration is performed with an aspirator, and a solid content remaining on filter paper is crushed with hands as fine as possible, is put in ion exchange water having a temperature of 30° C. that is 10 times the solid content, and is stirred for 30 minutes, and then, the suction filtration is performed again with the aspirator, and an electrical conductance of a filtrate is measured. Such an operation is repeated until the electrical conductance of the filtrate is 10 μS/cm or less, and the solid content is washed.

The washed solid content is finely crushed with a wet-dry granulator (COMIL), and is subjected to vacuum drying in an oven of 25° C. for 36 hours, and thus, pressure-responsive particles (1) are obtained. The pressure-responsive particles (1) have a volume average particle diameter of 8.0 μm.

The pressure-responsive particles (1) are used as a sample, thermal behavior in a temperature range of −150° C. to 100° C. is analyzed with a differential scanning calorimeter (DSC-60A, manufactured by SHIMADZU CORPORATION), and two glass transition temperatures are observed. The glass transition temperatures are shown in Table 3.

A temperature T1 and a temperature T2 of the pressure-responsive particles (1) are obtained by the measurement method described above, and the pressure-responsive particles (1) satisfy Expression 1 of “10° C. T1−T2”.

[Preparation of Pressure-Responsive Particles (2) to (4)]

Pressure-responsive particles (2) to (4) are prepared as with the preparation of the pressure-responsive particles (1), except that the composite resin particle dispersion liquid and the styrene-based resin particle dispersion liquid are changed as shown in Table 3.

[Preparation of Pressure-Responsive Particles (5)]
Composite Resin Particle Dispersion Liquid (M1): 504 parts
Ion Exchange Water: 710 parts
Anionic Surfactant (Dowfax2A1, manufactured by The Dow Chemical Company): 1 part

The materials described above are put in a reaction vessel provided with a thermometer and a pH meter, an aqueous solution of a nitric acid of 1.0% is added thereto at a temperature of 25° C. such that pH is adjusted to 3.0, and then, 23 parts of an aqueous solution of aluminum sulfate of 2.0% is added thereto while being dispersed with a homogenizer (ULTRA-TURRAX T50, manufactured by IKA-Werke GmbH & CO. KG) at the number of rotations of 5000 rpm. Next, a stirrer and a mantle heater are provided in the reaction vessel, the temperature is increased at a temperature increase rate of 0.2° C./minute up to a temperature of 40° C. and at a temperature increase rate of 0.05° C./minute after exceeding 40° C., and a particle diameter is measured with a Multisizer II (an aperture diameter of 50 μm, manufactured by Beckman Coulter, Inc.) every 10 minutes. The temperature is retained when a volume average particle diameter is 22.0 μm, and 170 parts of the styrene-based resin particle dispersion liquid (St1) is put therein for 5 minutes. After the input is ended, retention is performed at 50° C. for 30 minutes, and then, an aqueous solution of sodium hydroxide of 1.0% is added thereto such that the pH of slurry is adjusted to 6.0. Next, the temperature is increased to 90° C. at a temperature increase rate of 1° C./minute while the pH is adjusted to 6.0 every 5° C., and is retained at 90° C. The shape of the particles and surface properties are observed with an optical microscope and a field-emission scanning electron microscope (FE-SEM), and the coalescence of the particles is checked in 10 hours, and thus, the vessel is cooled with cooling water to 30° C. for 5 minutes.

The slurry after the cooling passes through a Nylon mesh having an opening of 50 um such that coarse particles are removed, and the slurry passing through the mesh is subjected to suction filtration with an aspirator. A solid content remaining on filter paper is crushed with hands as fine as possible, is put in ion exchange water having a temperature of 30° C. that is 10 times the solid content, and is stirred for 30 minutes. Next, suction filtration is performed with an aspirator, and a solid content remaining on filter paper is crushed with hands as fine as possible, is put in ion exchange water having a temperature of 30° C. that is 10 times the solid content, and is stirred for 30 minutes, and then, the suction filtration is performed again with the aspirator, and an electrical conductance of a filtrate is measured. Such an operation is repeated until the electrical conductance of the filtrate is 10 μS/cm or less, and the solid content is washed.

The washed solid content is finely crushed with a wet-dry granulator (COMIL), is subjected to vacuum drying in an oven of 25° C. for 36 hours, and thus, pressure-responsive particles (5) are obtained. The pressure-responsive particles (5) have a volume average particle diameter of 27.0 μm.

The pressure-responsive particles (5) are used as a sample, thermal behavior in a temperature range of −150° C. to 100° C. is analyzed with a differential scanning calorimeter (DSC-60A, manufactured by SHIMADZU CORPORATION), and two glass transition temperature are observed. The glass transition temperatures are shown in Table 3.

A temperature T1 and a temperature T2 of the pressure-responsive particles (5) are obtained by the measurement method described above, and the pressure-responsive particles (5) satisfy Expression 1 of “10° C. T1−T2”.

[Evaluation of Pressure-Responsive Phase Transition]

A temperature difference (T1−T3) that is an index indicating that the pressure-responsive particles are easily subjected to phase transition by pressure is obtained. The pressure-responsive particles are respectively used as a sample, a temperature T1 and a temperature T3 are measured with a flow tester (CFT-500, manufactured by SHIMADZU CORPORATION), and the temperature difference (T1−T3) is calculated. The temperature difference (T1−T3) is shown in Table 3.

TABLE 3

| | Composite | | | | | | | | | Pressure- |
|---|---|---|---|---|---|---|---|---|---|---|
| | resin | | | Mass ratio of | | | | | | responsive |
| Adhesive | particle | Polymerization | Polymerization | St-based resin | | | | Tg | | phase transition |
| resin | dispersion | component of | component of | to Ac-based | D50v | Tg | | difference | T3 | (T1-T3) |
| particles | liquid | St-based resin | Ac-based resin | resin (St:Ac) | μm | ° C. | ° C. | ° C. | ° C. | ° C. |
| (1) | M1 | St/BA/AA = 78/20/2 | 2EHA/BA = 50/50 | 50:50 | 8.0 | −52 | 54 | 106 | 75 | 15 |
| (2) | M2 | St/BA/AA = 88/10/2 | 2EHA/BA = 50/50 | 50:50 | 11.0 | −52 | 76 | 128 | 70 | 13 |
| (3) | M3 | St/2EHA/AA = 78/20/2 | 2EHA/BA = 50/50 | 50:50 | 9.5 | −52 | 56 | 108 | 75 | 20 |
| (4) | M4 | St/BA/AA = 78/20/2 | 2EHA/BA = 70/30 | 50:50 | 8.0 | −52 | 54 | 106 | 75 | 15 |
| (5) | M1 | St/BA/AA = 78/20/2 | 2EHA/BA = 50/50 | 50:50 | 27.0 | −52 | 54 | 106 | 75 | 15 |

<<Preparation of Heat-Responsive Particles>>

In adhesive resin particles (6), an ethylene acrylate copolymer (EA-209, manufactured by Sumitomo Seika Chemicals Company, Limited.) is used as heat-responsive particles.

The used heat-responsive particles have a volume average particle diameter of 10 and a melting point of 101° C.

<<Preparation of Polyimide Porous Film>>

As described below, a polyimide porous film is prepared.

<Preparation of Particles>

-Resin Particle Dispersion Liquid (1)-

300 parts by mass of styrene, 11.9 parts by mass of a surfactant Dowfax2A1 (a solution of 47%, manufactured by The Dow Chemical Company), and 150 parts by mass of deionized water are mixed, and are stirred with a dissolver at a rotation of 1,500 for 30 minutes to be emulsified, and thus, a monomer emulsified liquid is prepared. Subsequently, 0.9 parts by mass of Dowfax2A1 (a solution of 47%, manufactured by The Dow Chemical Company) and 446.8 parts by mass of deionized water are put in a reaction vessel. In a nitrogen stream, heating is performed at 75° C., and then, 24 parts by mass of the monomer emulsified liquid is added thereto. After that, a polymerization initiator solution in which 5.4 parts by mass of ammonium persulfate is dissolved in 25 parts by mass of deionized water is dropped for 10 minutes. After the dropping, a reaction is performed for 50 minutes, and then, the remaining monomer emulsified liquid is dropped for 180 minutes, a reaction is further performed for 180 minutes, and then, cooling is performed, and thus, a resin particle dispersion liquid (1) is obtained. A solid content concentration of the resin particle dispersion liquid (1) is 36.0 mass %. In addition, an average particle diameter of the resin particles is 0.38 μm.

<Preparation of Polyimide Precursor-Containing Liquid>

-Preparation of Polyimide Precursor-Containing Liquid (A)-

560.0 parts by mass of ion exchange water is heated to 50° C. in a nitrogen stream, 53.75 parts by mass of p-phenylene diamine and 146.25 parts by mass of a 3,3′,4,4′-biphenyl tetracarboxylic dianhydride are added thereto while being stirred. A mixture of 150.84 parts by mass of N-methyl morpholine (hereinafter, also referred to as “MMO”) and 89.16 parts by mass of ion exchange water is added thereto at 50° C. for 20 minutes in a nitrogen stream while being stirred. A reaction is performed at 50° C. for 15 hours, and thus, a polyimide precursor-containing liquid (A) containing the polyimide precursor (A) having a solid content concentration of 20 mass % is obtained.

<Polyimide Porous Film (1)>

169.85 parts of the polyimide precursor-containing liquid (A), 238.97 parts of the resin particle dispersion liquid (1), and 191.18 parts of an aqueous solvent (a mixed solution of NMP and water, Mass Ratio=17.83:173.35) are mixed.

The mixing is performed by ultrasonic dispersion at 50° C. for 30 minutes, and thus, a polyimide precursor solution in which the resin particles are dispersed is obtained. In addition, as described below, a polyimide porous film is obtained by using the obtained polyimide precursor solution.

A stainless steel substrate having a thickness of 1.0 mm, for forming a coated film of the polyimide precursor solution, is prepared. The polyimide precursor solution is applied onto the stainless steel substrate in an area of 10 cm×10 cm such that a film thickness after being applied and dried is 400 μm, by using an applicator, and thus, a coated film is obtained. The obtained coated film is heated and dried at 50° C. for 120 minutes (a first step).

After that, the temperature is increased at a rate of 10° C./minute, and is retained at 200° C. for 60 minutes, and then, cooling to a room temperature (25° C., the same applies hereinafter) is performed, and the coated film is dipped in tetrahydrofuran for 30 minutes in order to remove the resin particles (a second step).

Subsequently, the temperature is increased from a room temperature at a rate of 10° C./minute, and when the temperature reaches 350° C., the temperature is retained for 60 minutes (a third step).

After that, cooling to a room temperature is performed, and thus, a polyimide porous film (1) having a film thickness of 20 μm is obtained.

<Polyimide Porous Film (2)>

A polyimide precursor solution in which the resin particles are dispersed is obtained as with the polyimide porous film (1), except that 289.65 parts of the polyimide precursor-containing liquid (A), 172.41 parts of the resin particle dispersion liquid (1), and 137.94 parts of an aqueous solvent (a mixed solution of NMP and water, Mass Ratio=30.41:107.53) are mixed. Further, a polyimide porous film (2) is obtained as with Example 1, except that in the first step, heating and drying are performed at 80° C. by using the obtained polyimide precursor solution in which the resin particles are dispersed, in the second step, the temperature is retained at 200° C. for 60 minutes, and then, is retained at 350° C. for 60 minutes, and thus, the particles are heated and removed, and in the third step, when the temperature reaches 400° C., the temperature is retained for 60 minutes.

[Measurement and Calculation]

A porosity, an average pore diameter, a flatness, and a tensile breaking strength of the obtained polyimide porous film are obtained by the method described above.

Results are shown in Table 4.

An air permeance is measured by preparing a measurement sample of the air permeance from the obtained polyimide porous film, on the basis of an air permeance test method of Gurley type (JIS P 8117:2009), and by using the obtained measurement sample, in accordance with the method described above.

### Examples 1 to 10

Adhesive resin particles shown in Table 4 described below are applied onto on both surfaces of a polyimide porous film shown in Table 4 described below at an attachment amount shown in Table 4 described below, and thus, a separator is obtained.

### Comparative Example 1

0.2 μm of a liquid adhesive agent (epoxy resin-based CEMEDINE EP001N) is applied onto both surfaces of a polyimide porous film shown in Table 4 described below, and thus, a separator is obtained.

### Comparative Example 2

5.0 μm of a liquid adhesive agent (epoxy resin-based CEMEDINE EP001N) is applied onto both surfaces of a polyimide porous film shown in Table 4 described below, and thus, a separator is obtained.

### Evaluation

(Adhesive Strength)

The separator obtained as described above and a cathode active material layer of a cathode (a laminated body of a cathode collector and a cathode active material layer) are superimposed to be in contact with each other, and thus, a laminated structure is prepared, and the obtained laminated structure is heat-pressed in a thickness direction at 1 MPa and 80° C. for 20 seconds.

After that, the separator and the cathode are manually peeled off with tweezers, and an adhesive strength is evaluated in the following three stages. Results are shown in Table 4.

-Evaluation Criteria-

A: The cathode and the separator are peeled off with a strong force

B: The cathode and the separator are peeled off with a slightly strong force

C: The cathode and the separator are peeled off with a weak force

(Cycle Characteristics)

A lithium ion secondary battery having a configuration illustrated in the figure is prepared by using the separator obtained as described above.

Note that, the separator adheres to the cathode and the anode by heat-pressing the laminated structure in which the cathode, the separator, and the anode are laminated in this order in the thickness direction at 1 MPa and 80° C. for 20 seconds.

A reduction rate of a battery capacity at the time of repeating charge and discharge (specifically, 1C charge and 1C discharge at 25° C.) 500 times is examined by using the obtained secondary battery. It may be described that cycle characteristics are excellent as the reduction rate of the battery capacity is small. Results are shown in Table 4.

-Evaluation Criteria-

A: The reduction rate of the battery capacity is less than 20% (Excellent)

B: The reduction rate of the battery capacity is 20% or more and less than 40%

C: The reduction rate of the battery capacity is 40% or more (Poor)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

TABLE 4

| | | | | | | | | | | | Comparative | |
|---|---|---|---|---|---|---|---|---|---|---|---|---|
| | | Example | | | | | | | | | Example | |
| | | 1 | 2 | 3 | 4 | 5 | 6 | 7 | 8 | 9 | 1 | 2 |
| Polyimide | Type | (1) | (1) | (1) | (1) | (2) | (1) | (1) | (1) | (1) | (1) | (1) |
| porous film | Porosity [%] | 75 | 75 | 75 | 75 | 55 | 75 | 75 | 75 | 75 | 75 | 75 |
| | Air permeance [seconds/100 ml] | 28 | 28 | 28 | 28 | 73 | 28 | 28 | 28 | 28 | 28 | 28 |
| | Average pore diameter X [μm] | 0.40 | 0.40 | 0.40 | 0.40 | 0.40 | 0.40 | 0.40 | 0.40 | 0.40 | 0.40 | 0.40 |
| | Flatness | 0.1 | 0.1 | 0.1 | 0.1 | 0.4 | 0.1 | 0.1 | 0.1 | 0.1 | 0.1 | 0.1 |
| | Tensile breaking strength [MPa] | 31 | 31 | 31 | 31 | 75 | 31 | 31 | 31 | 31 | 31 | 31 |
| Adhesive resin | Type | (1) | (2) | (3) | (4) | (1) | (1) | (1) | (5) | (6) | — | — |
| particles | Average particle diameter Y [μm] | 8.0 | 11.0 | 9.5 | 8.0 | 8.0 | 8.0 | 8.0 | 27.0 | 10.0 | — | — |
| Ratio (Y/X) | | 20.0 | 27.5 | 23.8 | 20.0 | 20.0 | 20.0 | 20.0 | 50.0 | 16.1 | — | — |
| Attachment amount of adhesive | | 1.2 | 3.2 | 2.8 | 4.5 | 2.5 | 0.6 | 4.9 | 1.5 | 2.1 | — | — |
| resin particles [g/m²] | | | | | | | | | | | | |
| Evaluation | Adhesive strength | A | A | A | A | A | B | A | A | A | C | A |
| | Cycle characteristics | A | A | A | A | A | A | A | A | A | B | C |

What is claimed is:

1. A separator for a non-aqueous secondary battery, comprising:
a polyimide porous film; and
adhesive resin particles that are attached to a surface of the polyimide porous film and have a responsiveness to at least one of pressure and heat.

2. The separator for a non-aqueous secondary battery according to claim 1,
wherein when an average pore diameter of the polyimide porous film is set to X, and an average particle diameter of the adhesive resin particles is set to Y, a relationship of X<Y is satisfied.

3. The separator for a non-aqueous secondary battery according to claim 2,
wherein a ratio Y/X of the average particle diameter Y of the adhesive resin particles to the average pore diameter X of the polyimide porous film is more than 1.0 and 70.0 or less.

4. The separator for a non-aqueous secondary battery according to claim 1,
wherein an attachment amount of the adhesive resin particles with respect to the surface of the polyimide porous film is 0.5 g/m² or more and 5.0 g/m² or less.

5. The separator for a non-aqueous secondary battery according to claim 2,
wherein an attachment amount of the adhesive resin particles with respect to the surface of the polyimide porous film is 0.5 g/m² or more and 5.0 g/m² or less.

6. The separator for a non-aqueous secondary battery according to claim 3,
wherein an attachment amount of the adhesive resin particles with respect to the surface of the polyimide porous film is 0.5 g/m² or more and 5.0 g/m² or less.

7. The separator for a non-aqueous secondary battery according to claim 4,
wherein the attachment amount of the adhesive resin particles with respect to the surface of the polyimide porous film is 0.8 g/m² or more and 4.8 g/m² or less.

8. The separator for a non-aqueous secondary battery according to claim 5,
wherein the attachment amount of the adhesive resin particles with respect to the surface of the polyimide porous film is 0.8 g/m² or more and 4.8 g/m² or less.

9. The separator for a non-aqueous secondary battery according to claim 1,
wherein the adhesive resin particles are pressure-responsive particles.

10. The separator for a non-aqueous secondary battery according to claim 9,
wherein the pressure-responsive particles contain a styrene-based resin containing a styrene and a vinyl monomer other than the styrene as a polymerization component, and a (meth)acrylic ester-based resin containing at least two types of (meth)acrylic esters as a polymerization component, have at least two glass transition temperatures, and have a difference between the lowest glass transition temperature and the highest glass transition temperature of 30° C. or higher.

11. The separator for a non-aqueous secondary battery according to claim 10,
wherein a mass ratio of the at least two types of (meth)acrylic esters to the entire polymerization component of the (meth)acrylic ester-based resin is 90 mass % or more.

12. The separator for a non-aqueous secondary battery according to claim 10,
wherein a mass ratio of the styrene to the entire polymerization component of the styrene-based resin is 60 mass % or more and 95 mass % or less.

13. The separator for a non-aqueous secondary battery according to claim 10,
wherein two types of (meth)acrylic esters having a highest mass ratio in the at least two types of (meth)acrylic esters contained in the (meth)acrylic ester-based resin as the polymerization component are alkyl (meth)acrylic esters, and a difference in number of carbon atoms of alkyl groups between the alkyl (meth)acrylic esters is 1 or more and 4 or less.

14. The separator for a non-aqueous secondary battery according to claim 1,
wherein the polyimide porous film has a porosity of 50% or more and 90% or less and an air permeance of 5 seconds/100 mL or more and 100 seconds/100 mL or less.

15. The separator for a non-aqueous secondary battery according to claim 14,
wherein the polyimide porous film has the porosity of 55% or more and 85% or less.

16. The separator for a non-aqueous secondary battery according to claim 1,
wherein an average pore diameter of the polyimide porous film is 50 nm or more and 1500 nm or less.

17. The separator for a non-aqueous secondary battery according to claim 16,
wherein the average pore diameter of the polyimide porous film is 50 nm or more and 1000 nm or less.

18. The separator for a non-aqueous secondary battery according to claim 1,
wherein a tensile breaking strength of the polyimide porous film is 10 MPa or more.

19. A secondary battery, comprising:
an electrode; and
the separator for a non-aqueous secondary battery according to claim 1,
wherein an adhesive layer of the adhesive resin particles is provided between the electrode and the polyimide porous film.

20. A manufacturing method of a secondary battery, comprising:
allowing the separator for a non-aqueous secondary battery according to claim 1 to adhere to an electrode by at least one of pressure and heat.
